(19) United States
(12) Patent Application Publication
(10) Pub. No.: US 2017/0270378 A1
(43) Pub. Date: Sep. 21, 2017

(54) RECOGNITION DEVICE, RECOGNITION METHOD OF OBJECT, AND COMPUTER-READABLE RECORDING MEDIUM

(71) Applicant: Haike GUAN, Kanagawa (JP)

(72) Inventor: Haike GUAN, Kanagawa (JP)

(21) Appl. No.: 15/459,198

(22) Filed: Mar. 15, 2017

(30) Foreign Application Priority Data
Mar. 16, 2016 (JP) 2016-052740
Sep. 26, 2016 (JP) 2016-187016

(51) Int. Cl. G06K 9/00; B60R 1/00; G06T 7/70; H04N 7/18; G06K 9/46

(52) U.S. Cl. CPC G06K 9/00825; H04N 7/183; G06K 9/4604; G06K 9/00818; G06T 7/70; B60R 1/00; B60R 2300/307

(57) ABSTRACT

A recognition device includes an image acquirer, an object-candidate-region recognizer, and an object-shape recognizer. The image acquirer is configured to acquire image data. The object-candidate-region recognizer is configured to set an object-recognition-processing target region in an image of the image data based on an object-recognition-processing target-region dictionary including information of the object-recognition-processing target region. The object-recognition-processing target region is a search range of an object to be recognized in the image of the image data. The object-shape recognizer is configured to recognize a shape of the object in the object-recognition-processing target region. The object-shape recognizer generates the object-recognition-processing target-region dictionary including information of the object-recognition-processing target region that is set to include shapes of a plurality of objects recognized based on a plurality of pieces of the image data shot beforehand.

### CROSS-REFERENCE TO RELATED APPLICATIONS

The present application claims priority under 35 U.S.C. §119 to Japanese Patent Application No. 2016-052740, filed on Mar. 16, 2016 and Japanese Patent Application No. 2016-187016, filed on Sep. 26, 2016. The contents of which are incorporated herein by reference in their entirety.

### BACKGROUND OF THE INVENTION

1. Field of the Invention

The present invention relates to a recognition device, a recognition method of an object, and a computer-readable recording medium.

2. Description of the Related Art

A recognition device that recognizes and detects an object such as a traffic light, a vehicle, and a sign in an image shot by a camera has been known. For example, a technique that extracts pixels of a signal of each color of a traffic light in an image, and recognizes a shape of a region of the extracted pixels to detect the traffic light has been known. In the technique descried above, the traffic light is searched in all regions in the image, and thus the time required for recognizing the traffic light is long. Therefore, such a technique that detects a traffic light within a range preset in an image in association with a posture of a camera has been disclosed.

However, according to the technique described above, there is problem that a search range may not be appropriate depending on factors other than the posture, and an object to be recognized may not be included in the search range, resulting in making the detection accuracy of the object insufficient.

### SUMMARY OF THE INVENTION

According to one aspect of the present invention, a recognition device includes an image acquirer, an object-candidate-region recognizer, and an object-shape recognizer. The image acquirer is configured to acquire image data. The object-candidate-region recognizer is configured to set an object-recognition-processing target region in an image of the image data based on an object-recognition-processing target-region dictionary including information of the object-recognition-processing target region. The object-recognition-processing target region is a search range of an object to be recognized in the image of the image data. The object-shape recognizer is configured to recognize a shape of the object in the object-recognition-processing target region. The object-shape recognizer generates the object-recognition-processing target-region dictionary including information of the object-recognition-processing target region that is set to include shapes of a plurality of objects recognized based on a plurality of pieces of the image data shot beforehand.

### BRIEF DESCRIPTION OF THE DRAWINGS

FIG. 1 is a diagram illustrating an example of a vehicle mounted with a recognition device according to a first embodiment;

FIG. 2 is a block diagram illustrating a hardware configuration of the recognition device according to the first embodiment;

FIG. 3 is a functional block diagram of a recognition processor;

FIG. 4 is an example of an image including a traffic light to be adopted in signal recognition;

FIG. 5 is a flowchart of a dictionary generation processing for generating a signal-recognition-processing target-region dictionary, a signal recognition processing being performed by the recognition processor;

FIG. 6 is an explanatory diagram of shape recognition of signal regions, being regions of signals of respective colors of the traffic light in an image;

FIG. 7 is an explanatory diagram of a coordinate of a signal-recognition-processing target region extracted based on a plurality of signal regions;

FIG. 8 is a flowchart of object detection processing performed by the recognition processor;

FIG. 9 is an example of a daytime image including the traffic light and used in the object detection processing;

FIG. 10 is an example of a nighttime image including the traffic light and used in the object detection processing;

FIG. 11 is a flowchart of time period identifying processing performed by a time period identifier;

FIG. 12 is an explanatory diagram of a generation method of a time period identifying dictionary for identifying a shot time period of day and night according to an SVM;

FIG. 13 is a schematic diagram illustrating an example of an image including the traffic light shot during the night;

FIG. 14 is a diagram illustrating distribution of pixels of a nighttime signal in a (U, V) color space;

FIG. 15 is an explanatory diagram of a method of identifying a region of the pixels of the nighttime signal in the (U, V) color space and a region of pixels other than the nighttime signal;

FIG. 16 is a schematic diagram illustrating an example of an image including the traffic light shot during the day;

FIG. 17 is a diagram illustrating distribution of pixels in a daytime signal region in the (U, V) color space;

FIG. 18 is an explanatory diagram of a method of identifying a region of the pixels in the daytime signal region in the (U, V) color space, and a region of pixels in a region other than the daytime signal region;

FIG. 19 is a diagram of a pixel region obtained by extracting pixels of a region in which a signal color of a nighttime blue signal expands before expansion processing;

FIG. 20 is a diagram of a pixel region obtained by extracting the pixels of the region in which the signal color of the nighttime blue signal expands after the expansion processing;

FIG. 21 is a diagram of a pixel region obtained by extracting pixels in a region of a daytime blue signal before the expansion processing;

FIG. 22 is a diagram of a pixel region obtained by extracting the pixels in the region of the daytime blue signal after the expansion processing;

FIG. 23 is a diagram illustrating a circular signal region indicating an image of a nighttime blue signal, which is extracted by a signal-shape recognizer according to the Hough transform;

FIG. 24 is a diagram illustrating a recognition region of a circular signal region in which the signal-shape recognizer indicates the image of the nighttime blue signal;

FIG. 25 is a diagram illustrating a circular signal region indicating an image of a daytime blue signal, which is extracted by the signal-shape recognizer according to the Hough transform;

FIG. 26 is a diagram illustrating a recognition region of a circular signal region in which the signal-shape recognizer indicates the image of the daytime blue signal;

FIG. 27 is another diagram illustrating the recognition region of the circular signal region in which the signal-shape recognizer indicates the image of the daytime blue signal;

FIG. 28 is a block diagram illustrating a hardware configuration of the recognition device including an in-vehicle camera;

FIG. 29 is a functional block diagram of a recognition processor according to a second embodiment;

FIG. 30 is an example of an image acquired by an image acquirer;

FIG. 31 is a diagram in which a block is set in an image;

FIG. 32 is a diagram illustrating an example of a feature pattern in a dictionary block registered in a recognition dictionary for calculating a feature;

FIG. 33 is a diagram illustrating an example of a learning image sample;

FIG. 34 is a diagram of an object identifier provided in an object-shape recognizer;

FIG. 35 is an explanatory diagram of an object region in an image;

FIG. 36 is an explanatory diagram of a recognition result of the object region; and

FIG. 37 is an explanatory diagram of setting of an object-recognition-processing target region based on a plurality of object regions.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An object of an embodiment is to provide a recognition device, a recognition method of an object, and a computer-readable recording medium that can improve the detection accuracy.

In the embodiments and modifications exemplified below, identical constituent elements are included. Therefore, in the following descriptions, like constituent elements are denoted by like reference signs and redundant explanations thereof will be partially omitted. Parts included in the embodiments and modifications can be configured to be replaced with the corresponding ones of other embodiments and modifications. Configurations and positions of the parts included in the embodiments and modifications are identical to those of other embodiments and modifications, unless otherwise specified.

### First Embodiment

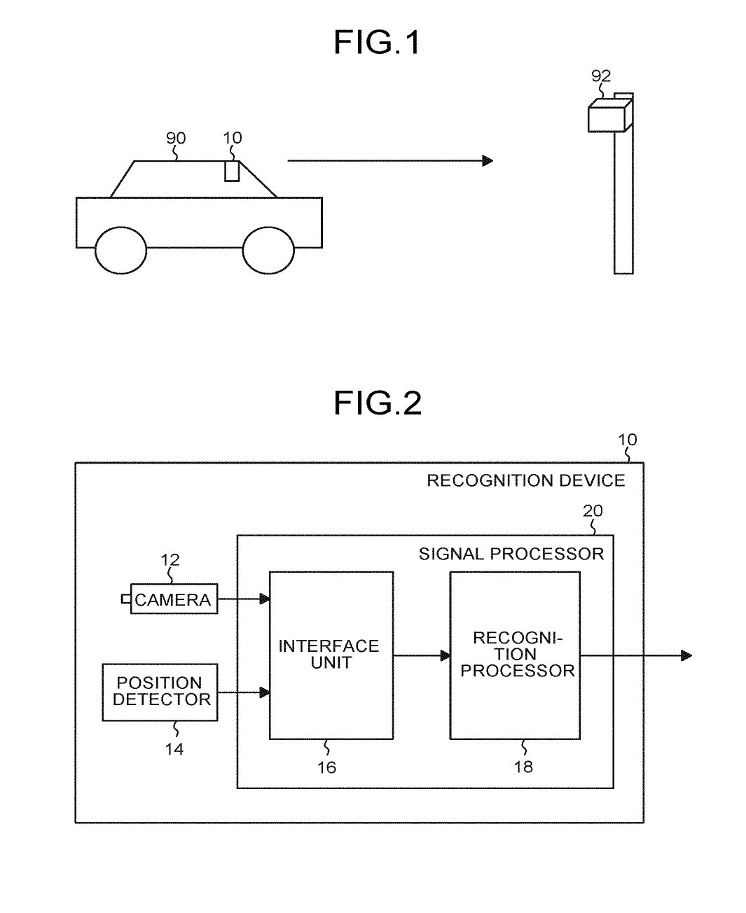

FIG. 1 is a diagram illustrating an example of a vehicle 90 mounted with a recognition device 10 according to a first embodiment. The recognition device 10 according to the first embodiment is installed on a front glass near a back mirror of the vehicle 90. The recognition device 10 according to the first embodiment shoots an object including a traffic light 92 as an object to be recognized, and recognizes and detects the traffic light 92 in image data of the shot image.

FIG. 2 is a block diagram illustrating a hardware configuration of the recognition device 10 according to the first embodiment. As illustrated in FIG. 2, the recognition device 10 includes a camera 2, a position detector 14, and a signal processor 20 having an interface unit 16 and a recognition processor 18.

The camera 12 is mounted on the vehicle 90 near the front glass. The camera 12 is connected to the interface unit 16 so as to be able to transmit and receive data such as image data. The camera 12 shoots an external object such as the traffic light 92 to generate image data such as a still image or a moving image. For example, the camera 12 generates image data of a moving image including a plurality of image frames, which continue in chronological order. The camera 12 can have an auto gain function that automatically adjusts brightness of the image data and maintains the brightness of the image data to be output to be constant, regardless of the brightness of the object. The camera 12 outputs the generated image data to the interface unit 16.

The position detector 14 is, for example, a terminal of a GPS (Global Positioning System). The position detector 14 detects a position of the recognition device 10. The position detector 14 outputs position information, being information related to the detected position, to the interface unit 16.

The interface unit 16 converts the image data that is acquired from the camera 12 and includes the image frames that continue in chronological order into image data in a data format that can be received by the recognition processor 18. The interface unit 16 outputs the image data in the converted data format to the recognition processor 18. The interface unit 16 outputs the position information acquired from the position detector 14 to the recognition processor 18.

The recognition processor 18 recognizes the traffic light 92 in the image shot by the camera 12 and outputs the traffic light 92.

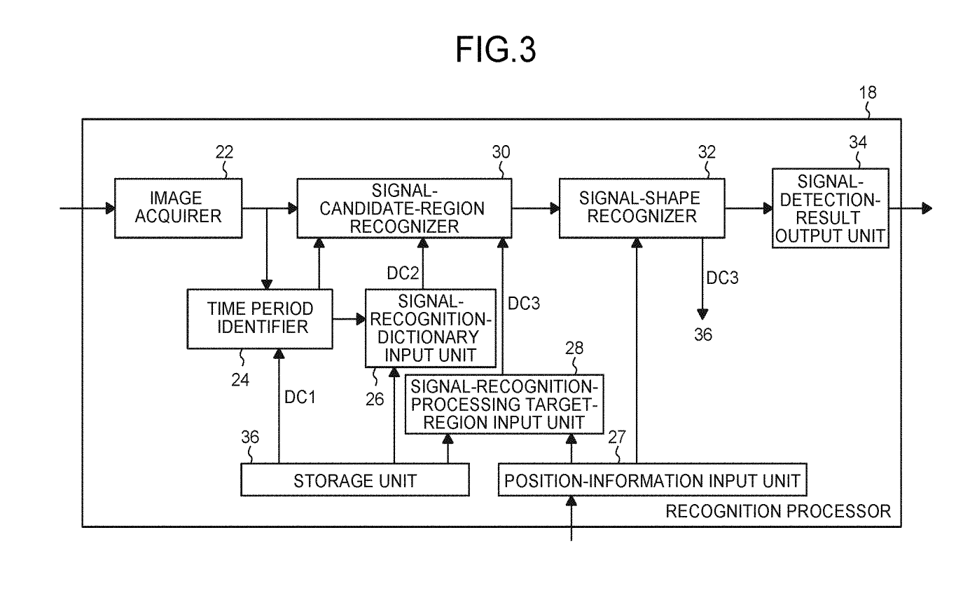

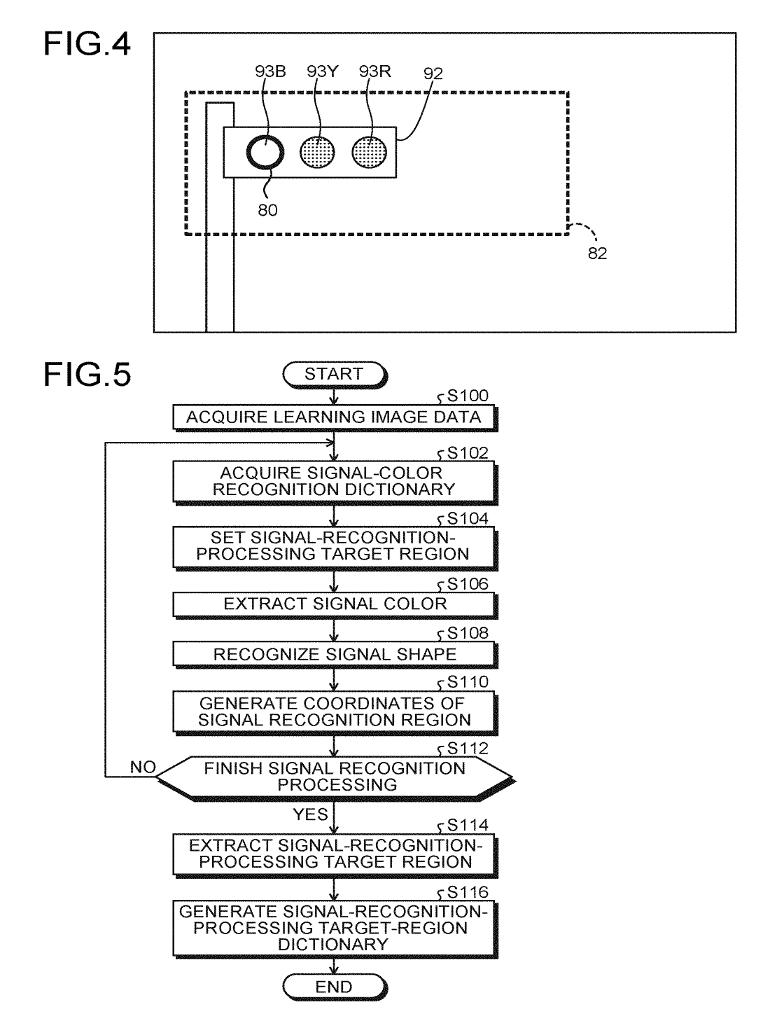

FIG. 3 is a functional block diagram of the recognition processor 18. FIG. 4 is an example of an image including the traffic light 92 to be adopted in signal recognition. As illustrated in FIG. 3, the recognition processor 18 includes an image acquirer 22, a time period identifier 24, a signal-recognition-dictionary input unit 26, a position-information input unit 27, a signal-recognition-processing target-region input unit 28, a signal-candidate-region recognizer 30 as an example of an object-candidate-region recognizer, a signal-shape recognizer 32 as an example of an object-shape recognizer, a signal-detection-result output unit 34, and a storage unit 36. The recognition processor 18 is, for example, a computer having an arithmetic processing unit such as a processor. The recognition processor 18 functions as the image acquirer 22, the time period identifier 24, the signal-recognition-dictionary input unit 26, the position-information input unit 27, the signal-recognition-processing target-region input unit 28, the signal-candidate-region recognizer 30, the signal-shape recognizer 32, and the signal-detection-result output unit 34.

The image acquirer 22 acquires image data of an image as illustrated in FIG. 4, including the traffic light 92 having a blue signal 93B, a yellow signal 93Y, and a red signal 93R shot by the camera 12, from the interface unit 16. When it is not necessary to distinguish the colors of the signals 93B, 93Y, and 93R, the signal is only described as a signal 93. The image acquirer 22 outputs the acquired image data to the signal-candidate-region recognizer 30 and the time period identifier 24.

The time period identifier 24 identifies the time period of the image data acquired from the image acquirer 22, based on a time period identifying dictionary DC1 generated beforehand and stored in the storage unit 36. For example, the time period identifier 24 identifies in which time period during the day or during the night the image has been shot. The time period identifier 24 outputs a identifying result, being a result of identifying, to the signal-candidate-region recognizer 30 and the signal-recognition-dictionary input unit 26.

The signal-recognition-dictionary input unit 26 acquires a signal-color recognition dictionary DC2 from the storage unit 36. The signal-recognition-dictionary input unit 26 selects a signal-color recognition dictionary DC2 of the time period during the day or during the night corresponding to the identifying result output from the time period identifier 24. The signal-recognition-dictionary input unit 26 input the selected signal-color recognition dictionary DC2 to the signal-candidate-region recognizer 30.

The position-information input unit 27 acquires position information, being information related to the position of the vehicle 90 or the recognition device 10 detected by the position detector 14. The position-information input unit 27 acquires the position information, for example, when the image acquirer 22 acquires the image data. The position-information input unit 27 outputs the position information for acquiring a signal-recognition-processing target-region dictionary DC3 corresponding to the position to the signal-recognition-processing target-region input unit 28. The signal-recognition-processing target-region dictionary DC3 is an example of an object-recognition-processing target-region dictionary. The position-information input unit 27 can output the position information to the signal-shape recognition unit 32.

The signal-recognition-processing target-region input unit 28 acquires the signal-recognition-processing target-region dictionary DC3 including information related to a signal-recognition-processing target region 82 being a search range of the signal 93 of the traffic light 92 in the image of the image data illustrated in FIG. 4, from the storage unit 36. The signal-recognition-processing target region is an example of an object-recognition-processing target region. The information related to the signal-recognition-processing target region 82 is, for example, coordinate data of the signal-recognition-processing target region 82 in the image. The signal-recognition-processing target-region input unit 28 inputs the signal-recognition-processing target-region dictionary DC3 to the signal-candidate-region recognizer 30. The signal-recognition-processing target-region input unit 28 can select the signal-recognition-processing target-region dictionary DC3 corresponding to the position indicated by the position information based on the position information acquired from the position-information input unit 27 and input the selected signal-recognition-processing target-region dictionary DC3 to the signal-candidate-region recognizer 30.

The signal-candidate-region recognizer 30 sets the signal-recognition-processing target region 82 as illustrated in FIG. 4 in the image acquired from the image acquirer 22, based on the signal-recognition-processing target-region dictionary DC3. For example, the signal-candidate-region recognizer 30 sets the signal-recognition-processing target region 82 in the image for each color of the signal 93. The signal-candidate-region recognizer 30 recognizes and extracts the pixels of the color of each signal 93 of the traffic light 92 in the signal-recognition-processing target region 82 set in the image, based on the signal-color recognition dictionary DC2. For example, the signal-candidate-region recognizer 30 can recognize the pixels of the color of the signal 93 included in the signal-recognition-processing target region 82 based on the signal-color recognition dictionary DC2 corresponding to the time period. The signal-candidate-region recognizer 30 outputs the extracted pixel data to the signal-shape recognizer 32.

The signal-shape recognizer 32 detects the shape of a signal region 80, being the region of the signal 93, for each color in the signal-recognition-processing target region 82 based on the pixel data of each color acquired from the signal-candidate-region recognizer 30, and recognizes the detected shape as the shape of the signal 93 of the traffic light 92. The signal-shape recognizer 32 outputs a result of detection of the traffic light 92 based on the shape of the recognized signal region 80 to the signal-detection-result output unit 34 as a detection result.

The signal-shape recognizer 32 generates or updates the signal-recognition-processing target-region dictionary DC3 according to a learning method such as an SVM (Support Vector Machine) machine learning technique. Specifically, the signal-shape recognizer 32 acquires a plurality of pieces of image data of the pre-shot image. The signal-shape recognizer 32 recognizes the shape of the plurality of signals 93 in the plurality of images for each color of the signal 93, based on the pieces of image data. The signal-shape recognizer 32 generates information (for example, coordinate data) of the signal-recognition-processing target region 82 so as to be set to include the plurality of recognized signals 93. The signal-shape recognizer 32 generates or updates the signal-recognition-processing target-region dictionary DC3 including the information of the signal-recognition-processing target region 82. The signal-shape recognizer 32 stores the generated or updated signal-recognition-processing target-region dictionary DC3 in the storage unit 36.

The signal-shape recognizer 32 can generate the signal-recognition-processing target-region dictionary DC3 including the information (for example, coordinate data) of a plurality of signal-recognition-processing target regions 82. Further, the signal-shape recognizer 32 can update the signal-recognition-processing target-region dictionary DC3 by the information (for example, coordinate data) of a signal-recognition-processing target region 82 newly set based on new image data.

For example, the signal-shape recognizer 32 can generate the signal-recognition-processing target-region dictionary DC3 including the information (for example, coordinate data) of a plurality (for example, three) of signal-recognition-processing target regions 82 associated with respective colors of the blue signal 93B, the yellow signal 93Y, and the red signal 93R of the traffic light 92.

The signal-shape recognizer 32 can generate the signal-recognition-processing target-region dictionary DC3 including the information (for example, coordinate data) of the plurality of signal-recognition-processing target regions 82 set for each different state. Specifically, the signal-shape recognizer 32 acquires pieces of image data in different states from the image acquirer 22. The signal-shape recognizer 32 can generate the signal-recognition-processing target-region dictionary DC3 including coordinate data of the signal-recognition-processing target regions 82 set for each of the different states based on the pieces of image data.

When the surrounding state has changed, the signal-shape recognizer 32 can update the signal-recognition-processing target-region dictionary DC3 based on the information (for example, coordinate data) of a signal-recognition-processing target region 82 newly set based on new image data.

The signal-shape recognizer 32 can generate the signal-recognition-processing target-region dictionary DC3 including the information (for example, coordinate data) of the plurality of signal-recognition-processing target regions 82 associated with each of a plurality of time periods. Specifically, the signal-shape recognizer 32 acquires pieces of image data (an example of first image data) of a first time period (for example, a time period during the day), and pieces of image data of a second time period (for example, a time period during the night) different from the first time period from the image acquirer 22. The signal-shape recognizer 32 can generate the signal-recognition-processing target-region dictionary DC3 including coordinate data of the signal-recognition-processing target region 82 set by the pieces of image data in the first time period, and coordinate data of the signal-recognition-processing target region 82 set by the pieces of image data in the second time period (an example of second image data).

The signal-shape recognizer 32 can generate the signal-recognition-processing target-region dictionary DC3 including information (for example, coordinate data) of the plurality of signal-recognition-processing target regions 82 respectively associated with a plurality of areas including a plurality of positions of the vehicle 90 or the recognition device 10. Specifically, the signal-shape recognizer 32 acquires the position information being information related to the position of the vehicle 90 or the recognition device 10 from the position-information input unit 27. The signal-shape recognizer 32 can generate the signal-recognition-processing target-region dictionary DC3 including the coordinate data of the signal-recognition-processing target region 82 set in a first area set corresponding to the position information, and the coordinate data of the signal-recognition-processing target region 82 set in a second area, which is different from the first area, set corresponding to the position information. Further, if the information of the signal-recognition-processing target region 82 corresponding to the current position has not been registered in the signal-recognition-processing target-region dictionary DC3, the signal-shape recognizer 32 can add the information of a new signal-recognition-processing target region 82 set with respect to an area including the current position to the signal-recognition-processing target-region dictionary DC3, based on the position information acquired from the position-information input unit 27.

The signal-shape recognizer 32 can generate the signal-recognition-processing target-region dictionary DC3 including the information (for example, coordinate data) of the signal-recognition-processing target region 82 set based on pieces of image data of a preset area and in a preset time period based on the position information of the vehicle 90 or the recognition device 10 acquired from the position-information input unit 27. In this case, it is desired that the signal-shape recognizer 32 registers the coordinate data of the signal-recognition-processing target region 82 in association with both the area and the time period in the signal-recognition-processing target-region dictionary DC3.

The signal-detection-result output unit 34 outputs a detection result of the traffic light 92 to a voice output device, a display device or the like.

The storage unit 36 is a memory device such as a ROM (Read Only Memory), a RAM (Random Access Memory), an HDD (Hard Disk Drive), and an SDRAM (Synchronous Dynamic RAM) that store a program for detecting the traffic light 92 and dictionaries DC1, DC2, and DC3 required for the execution of the program.

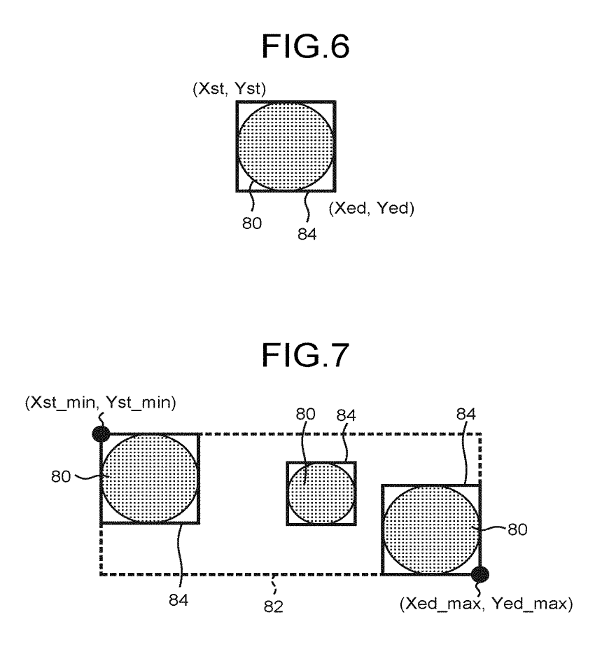

FIG. 5 is a flowchart of a dictionary generation processing for generating the signal-recognition-processing target-region dictionary DC3 performed by the recognition processor 18. FIG. 6 is an explanatory diagram of shape recognition of the signal regions 80, being regions of the signals 93 of the respective colors of the traffic light 92 in an image. FIG. 7 is an explanatory diagram of a coordinate of the signal-recognition-processing target region 82 extracted based on a plurality of signal regions 80.

As illustrated in FIG. 5, in the dictionary generation processing, the image acquirer 22 acquires learning image data including a plurality of image frames of an image as illustrated in FIG. 4 from the storage unit 36 (S100). The image data can be a still image or a moving image. For example, the image acquirer 22 can acquire image data that has been stored in the storage unit 36 beforehand by converting the format of the image data generated by the camera 12 by the interface unit 16. The image data can be obtained at a time different from the time period in which the dictionary generation processing is performed. For example, the learning image data can be image data of a moving image shot during the day when the camera 12 can recognize the traffic light 92 easily. The image acquirer 22 outputs the acquired image data to the time period identifier 24 and the signal-candidate-region recognizer 30.

The signal-recognition-dictionary input unit 26 acquires the signal-color recognition dictionary DC2 for extracting the color pixels of the signal 93 from the storage unit 36 and outputs the signal-color recognition dictionary DC2 to the signal-candidate-region recognizer 30 (S102). When having acquired the identifying result of identifying the time period from the time period identifier 24, the signal-recognition-dictionary input unit 26 can output the signal-color recognition dictionary DC2 of the time period to the signal-candidate-region recognizer 30.

The signal-candidate-region recognizer 30 recognizes and sets the signal-recognition-processing target region 82, being a candidate of a region in the image, in which pixels are extracted for each color of the signals 93 from the image data (S104). When having acquired the signal-recognition-processing target-region dictionary DC3 stored beforehand, the signal-candidate-region recognizer 30 can set the signal-recognition-processing target region 82 based on the signal-recognition-processing target-region dictionary DC3. Further, if there is no signal-recognition-processing target-region dictionary DC3, the signal-candidate-region recognizer 30 can set the entire image as the signal-recognition-processing target region 82 of an initial value. The signal-candidate-region recognizer 30 outputs the extracted pixel data and the signal-recognition-processing target region 82 to the signal-shape recognizer 32.

The signal-candidate-region recognizer 30 extracts pixels of the respective colors of the signals 93 included in the signal-recognition-processing target region 82 from the signal-recognition-processing target region 82 of the image data acquired from the image acquirer 22, based on the signal-color recognition dictionary DC2 (S106). For example, the signal-candidate-region recognizer 30 recognizes and extracts the respective pixels of blue, yellow, and red of the blue signal 93B, the yellow signal 93Y, and the red signal 93R.

The signal-shape recognizer 32 performs recognition processing for recognizing the shapes of the signal regions 80 of the respective colors of the signal 93 illustrated in FIG. 6, with respect to the pixels in the signal-recognition-processing target region 82 in the image (S108). Specifically, the signal-shape recognizer 32 recognizes the shape of the signal 93 of the respective colors of the traffic light 92 as a circular signal region 80.

The signal-shape recognizer 32 sets a rectangular region circumscribed to the signal region 80 as a recognition region 84, and generates a coordinate of the recognition region 84 (S110). The signal-shape recognizer 32 recognizes, for example, a rectangular shape with two sides being parallel to a horizontal direction and other two sides being parallel to a vertical direction, as the recognition region 84. The signal-shape recognizer 32 generates two apexes opposite to each other of the rectangular recognition region 84, for example, coordinate data of an upper left apex (Xst[i], Yst[i]) and coordinate data of a lower right apex (Xed[i], Yed[i]) as information related to the recognition region 84 of the signal region 80. In other words, the signal-shape recognizer 32 generates coordinate data of the apexes on one diagonal line of the rectangular recognition region 84 as the information related to the recognition region 84. The signal-shape recognizer 32 generates a set of coordinate data (Xst[i], Yst[i]) and (Xed[i], Yed[i]) of a plurality of recognition regions 84. Here, “i” is a positive integer for identifying which image data is the coordinate data of the recognition region 84. The signal-shape recognizer 32 generates a set of pieces of coordinate data (Xst[i], Yst[i]) and (Xed[i], Yed[i]) of the recognition region 84 for each color of the signal 93.

The signal-shape recognizer 32 determines whether the recognition processing for recognizing the recognition region 84 of the signal 93 has finished (S112). Upon determining that the recognition processing of the recognition region 84 has not finished (NO at S112), the signal-shape recognizer 32 repeats Step S102 and steps thereafter. Accordingly, the signal-shape recognizer 32 generates a set of pieces of coordinate data (Xst[i], Yst[i]) and (Xed[i], Yed[i]) generated based on the plurality of traffic lights 92 in the pieces of image data, for each color.

Meanwhile, the signal-shape recognizer 32 extracts the coordinate data (Xst, Yst), (Xed, Yed) of the recognition region 84, for example, from all the acquired pieces of learning image data, and upon determining that the recognition processing has finished, the signal-shape recognizer 32 performs Step S114. Specifically, the signal-shape recognizer 32 extracts a signal-recognition-processing target region 82, which is a region having high possibility of appearance in the image of the recognition region 84, from the recognition region 84 of the signal regions 80 recognized at Step S108 (S114). For example, as illustrated in FIG. 7, the signal-shape recognizer 32 obtains a minimum value (Xst_min, Yst_min) obtained from the pieces of coordinate data (Xst, Yst) at the upper left apex of the plurality of recognition regions 84, and a maximum value (Xed_max, Yed_max) obtained from the pieces of coordinate data (Xed, Yed) at the lower right apex of the recognition regions 84, as the coordinate data that defines the signal-recognition-processing target region 82. In other words, the signal-shape recognizer 32 sets the coordinates of the two opposing apexes of the rectangle including the signal region 80, which is the shape of the plurality of signals 93 recognized by the pieces of image data, as the information of the signal-recognition-processing target region 82.

The signal-shape recognizer 32 generates the signal-recognition-processing target-region dictionary DC3 having the information of the signal-recognition-processing target region 82 including the generated coordinate data (Xst_min, Yst_min) and coordinate data (Xed_max, Yed_max) (S116). When the signal-recognition-processing target-region dictionary DC3 is already present, at Step S116, the signal-shape recognizer 32 updates the signal-recognition-processing target-region dictionary DC3 by the coordinate data (Xst_min, Yst_min) and the coordinate data (Xed_max, Yed_max). The signal-shape recognizer 32 stores the generated signal-recognition-processing target-region dictionary DC3 in the storage unit 36. Accordingly, the recognition processor 18 finishes the dictionary generation processing.

The recognition processor 18 can perform the dictionary generation processing when the state of the recognition device 10 has changed, to generate or update the signal-recognition-processing target-region dictionary DC3. For example, the recognition processor 18 can generate or update the signal-recognition-processing target-region dictionary DC3 by performing the dictionary generation processing for each fixed cycle. In this case, the signal-shape recognizer 32 can delete the old information of the signal-recognition-processing target region 82 and add information of a new signal-recognition-processing target region 82 to the signal-recognition-processing target-region dictionary DC3.

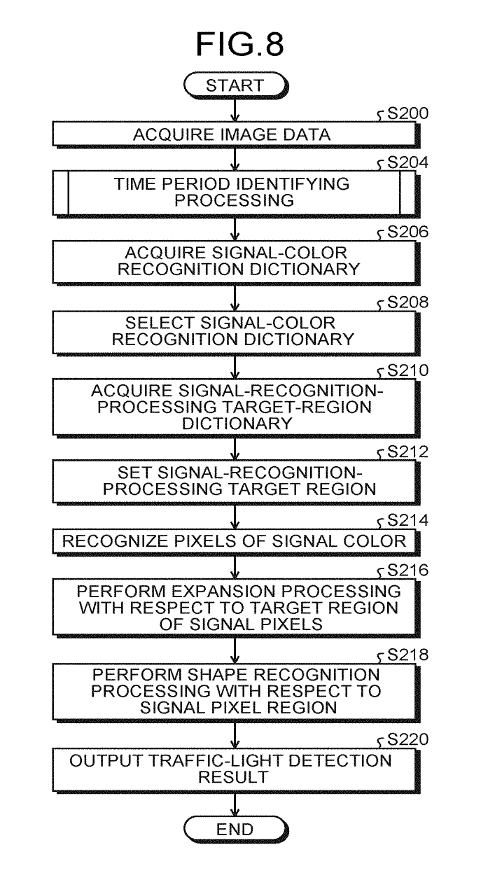

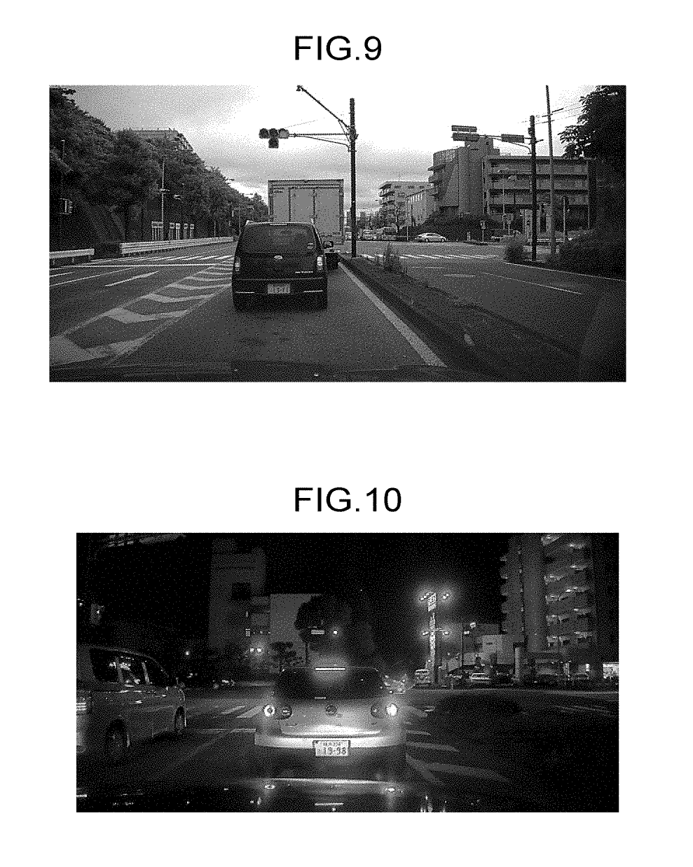

FIG. 8 is a flowchart of object detection processing being an example of the recognition method performed by the recognition processor 18. FIG. 9 is an example of a daytime image including the traffic light 92 and used in the object detection processing. FIG. 10 is an example of a nighttime image including the traffic light 92 and used in the object detection processing.

As illustrated in FIG. 8, in the object detection processing, the image acquirer 22 acquires image data of an image illustrated in FIG. 9 or FIG. 10 shot by the camera 12 via the interface unit 16, and outputs the image data to the time period identifier 24 and the signal-candidate-region recognizer 30 (S200).

The time period identifier 24 identifies in which time period during the day or during the night the image data has been taken (S204). For example, the time period identifier 24 can discriminate whether the shot time period is during the day or night according to the luminance of the image data. The time period of the image data is different from the time of actual shooting, depending on the season, area, and country, even in the case of the same shot contents (for example, the same luminance). For example, the length of the daytime is different in the summer and in the winter. The daytime in the summer is long and the nighttime is short in the northern hemisphere. Therefore, it is desired that the time period identifier 24 identifies day and night by defining the shot time period according to the contents of the image data.

For example, the time period identifier 24 defines the image as illustrated in FIG. 9 as a sample of a daytime image and collects a plurality of daytime image samples beforehand. The time period identifier 24 can suppress influences due to the season, area, and the like by identifying the day time period based on the daytime image samples. Further, the time period identifier 24 defines the image as illustrated in FIG. 10 as a sample of a nighttime image and collects a plurality of nighttime image samples beforehand. The time period identifier 24 can suppress influences due to the season, area, and the like by identifying the nighttime period based on the nighttime image samples.

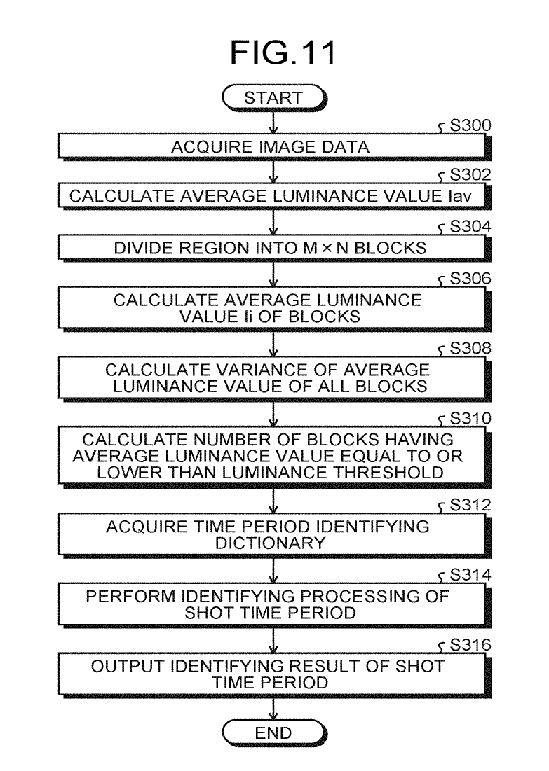

An example of time period identifying processing by means of luminance that is performed by the time period identifier 24 is described next. FIG. 11 is a flowchart of the time period identifying processing performed by the time period identifier 24.

As illustrated in FIG. 11, in the time period identifying processing, the time period identifier 24 acquires image data from the image acquirer 22 (S300). The time period identifier 24 then calculates an average luminance value Iav, being an average value of the luminance of the entire area of the image (S302). Generally, the average luminance value Iav of an image shot during the day is higher than that of an image shot during the night. Therefore, the time period identifier 24 uses the average luminance value Iav as one of features for identifying day and night.

The time period identifier 24 divides the entire region of the image into M×N blocks Blki (S304). The block Blki indicates the ith block. For example, the time period identifier 24 divides the entire region of the image into 64×48 blocks Blki.

The time period identifier 24 calculates an average luminance value Ii of the whole divided blocks Blki (S306). The average luminance value Ii indicates an average luminance value of the ith block Blki.

The time period identifier 24 calculates a variance of the average luminance value Ii of the calculated respective blocks Blki based on the following equation (1) (S308). The time period identifier 24 uses the calculated variance σ as one of the features for identifying day and night.

$$σ = \sqrt[2]{{\sum }_{i = 0}^{M \times N} {( li - lav )}^{2}} \qquad ( 1 )$$

The time period identifier 24 calculates the number of blocks Blki having the average luminance value Ii equal to or lower than a preset luminance threshold Ith, and sets the number as the number of low-luminance blocks Nblk (S310). The time period identifier 24 uses the number of low-luminance blocks Nblk as one of the features for identifying day and night.

The time period identifier 24 acquires the time period identifying dictionary DC1 for identifying the shot time period from the storage unit 36 (S312). The generation method of the time period identifying dictionary DC1 is described later.

The time period identifier 24 identifies day and night based on the respective features and the time period identifying dictionary DC1 (S314). The time period identifier 24 identifies day and night based on the time period identifying dictionary DC1 generated, for example, based on the machine learning technique by an SVM.

A case where the time period identifier 24 identifies day and night by using the average luminance value Iav and the number of low-luminance blocks Nblk as the features is described here. First, the time period identifier 24 identifies day and night by using f(Iav, Nblk) indicated in the following equation (2) as a linear evaluation function.

f(Iav,Nblk)=A×Iav+B×Nblk+C (2)

Here, A, B, and C in the equation (2) are coefficients of the evaluation function f(Iav, Nblk) calculated beforehand by the time period identifier 24 according to the SVM machine learning technique, and registered in the time period identifying dictionary DC1. If a value of the evaluation function f(Iav, Nblk) indicated by the equation (2) into which the average luminance value Iav and the number of low-luminance blocks Nblk of the image data to be identified are substituted is equal to or larger than a preset time period threshold Tth, the time period identifier 24 identifies that the shot time period is daytime. On the other hand, if a value of the evaluation function f(Iav, Nblk) into which the average luminance value Iav and the number of low-luminance blocks Nblk of the image data to be identified are substituted is smaller than the preset time period threshold Tth, the time period identifier 24 identifies that the shot time period is nighttime.

A case where the time period identifier 24 identifies day and night by using the variance σ as the feature in addition to the average luminance value Iav and the number of low-luminance blocks Nblk is described. In this case, the time period identifier 24 identifies day and night by using f(Iav, Nblk, σ) indicated in the following equation (3) as a linear evaluation function.

f(Iav,Nblk,σ)A×Iav+B×Nblk+C×σ+D (3)

Here, A, B, C, and D in the equation (3) are coefficients of the evaluation function f(Iav, Nblk, σ) calculated beforehand by the time period identifier 24 according to the SVM machine learning technique, and registered in the time period identifying dictionary DC1. If a value of the evaluation function f(Iav, Nblk, σ) indicated by the equation (3) into which the average luminance value Iav, the number of low-luminance blocks Nblk, and the variance σ of the image data to be identified are substituted is equal to or larger than the preset time period threshold Tth, the time period identifier 24 identifies that the shot time period is daytime. On the other hand, if a value of the evaluation function f(Iav, Nblk, σ) into which the average luminance value Iav, the number of low-luminance blocks Nblk, and the variance σ of the image data to be identified are substituted is smaller than the preset time period threshold Tth, the time period identifier 24 identifies that the shot time period is nighttime.

The time period identifier 24 outputs the shot time period identified based on the evaluation function f(Iav, Nblk) or the evaluation function f(Iav, Nblk, σ) as a identifying result to the signal-recognition-dictionary input unit 26 and the signal-candidate-region recognizer 30 (S316). Accordingly, the time period identifier 24 finishes the time period identifying processing illustrated in FIG. 11.

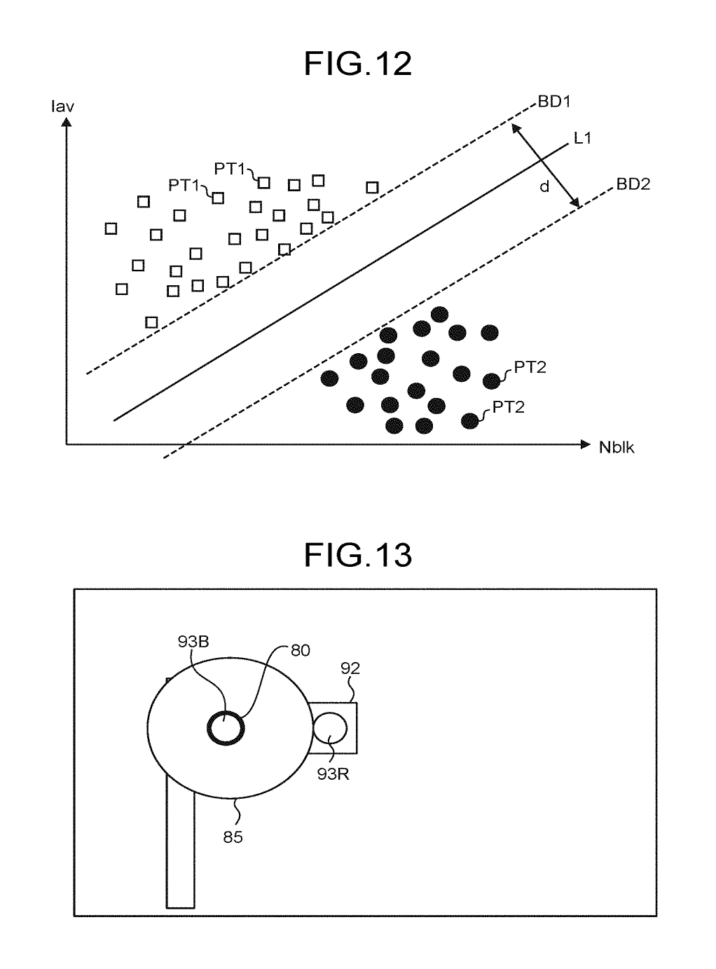

The generation processing of the time period identifying dictionary DC1 by the time period identifier 24 is described next. FIG. 12 is an explanatory diagram of a generation method of the time period identifying dictionary DC1 for identifying the shot time period of day and night according to the SVM machine learning technique.

As illustrated in FIG. 12, in a two-dimensional space in which the average luminance value Iav is plotted on a longitudinal axis and the number of low-luminance blocks Nblk is plotted on a horizontal axis, respective pieces of image data having the average luminance value Iav and the number of low-luminance blocks Nblk as the features become one point on the two-dimensional space. In FIG. 12, pieces of daytime image data PT1 shot during the day are indicated by outlined squares, and pieces of nighttime image data PT2 shot during the night are indicated by black circles. A solid line L1 that divides the daytime image data PT1 and the nighttime image data PT2 indicates the evaluation function f(Iav, Nblk). A dotted line indicates a borderline BD1 of the daytime image data PT1 and a borderline BD2 of the nighttime image data PT2. The borderlines BD1 and BD2 are parallel to the solid line L1. For example, the time period identifier 24 calculates the solid line L1 with which a distance d between the borderline BD1 of the daytime image data PT1 and the borderline BD2 of the nighttime image data PT2 becomes maximum. The time period identifier 24 calculates the coefficients A, B, and C by setting the calculated solid line L1 as the evaluation function f(Iav, Nblk), and registers the coefficients A, B, and C in the time period identifying dictionary DC1. The time period identifier 24 identifies day and night of the image data based on the time period identifying dictionary DC1.

When identifying the image data in three or more time periods other than day and night (for example, day, evening, night), the time period identifier 24 can generate the time period identifying dictionary DC1 respectively corresponding thereto beforehand, and performs the time period identifying processing plural times based on the respective time period identifying dictionaries DC1, thereby identifying in which time period the image data to be identified is.

Referring back to FIG. 8, the signal-recognition-dictionary input unit 26 acquires the signal-color recognition dictionary DC2 from the storage unit 36 (S206).

The signal-recognition-dictionary input unit 26 outputs the signal-color recognition dictionary DC2 selected according to the identifying result of the time period acquired from the time period identifier 24, to the signal-candidate-region recognizer 30 (S208). If the identifying result acquired from the time period identifier 24 indicates a daytime time period, the signal-recognition-dictionary input unit 26 outputs the signal-color recognition dictionary DC2 for daytime to the signal-candidate-region recognizer 30. If the identifying result acquired from the time period identifier 24 indicates a nighttime time period, the signal-recognition-dictionary input unit 26 outputs the signal-color recognition dictionary DC2 for nighttime to the signal-candidate-region recognizer 30.

The signal-recognition-processing target-region input unit 28 acquires the preset signal-recognition-processing target-region dictionary DC3 from the storage unit 36 and outputs the signal-recognition-processing target-region dictionary DC3 to the signal-candidate-region recognizer 30 (S210). When having acquired the position information from the position-information input unit 27, the signal-recognition-processing target-region input unit 28 can output the signal-recognition-processing target-region dictionary DC3 including the information of the signal-recognition-processing target region 82 associated with an area including the position indicated by the position information, to the signal-candidate-region recognizer 30.

The signal-candidate-region recognizer 30 sets the signal-recognition-processing target region 82 for searching for the signal 93 of the traffic light 92 in an image of the image data based on the signal-recognition-processing target-region dictionary DC3 (S212).

The signal-candidate-region recognizer 30 recognizes pixels of colors of the respective signals 93 of the traffic light 92 in the signal-recognition-processing target region 82 (S214). The signal-candidate-region recognizer 30 extracts the pixels of the respective signals 93 of the traffic light 92 by converting the pixels in an (R, G, B) color space of the acquired image data to pixels in a (Y, U, V) color space.

$$[ \begin{matrix}Y \\ U \\ V\end{matrix} ] = [ \begin{matrix}0.299 & 0.587 & 0.114 \\ - 0.147 & - 0.289 & 0.436 \\ 0.615 & - 0.515 & 0.100\end{matrix} ] [ \begin{matrix}R \\ G \\ B\end{matrix} ] \qquad ( 4 )$$

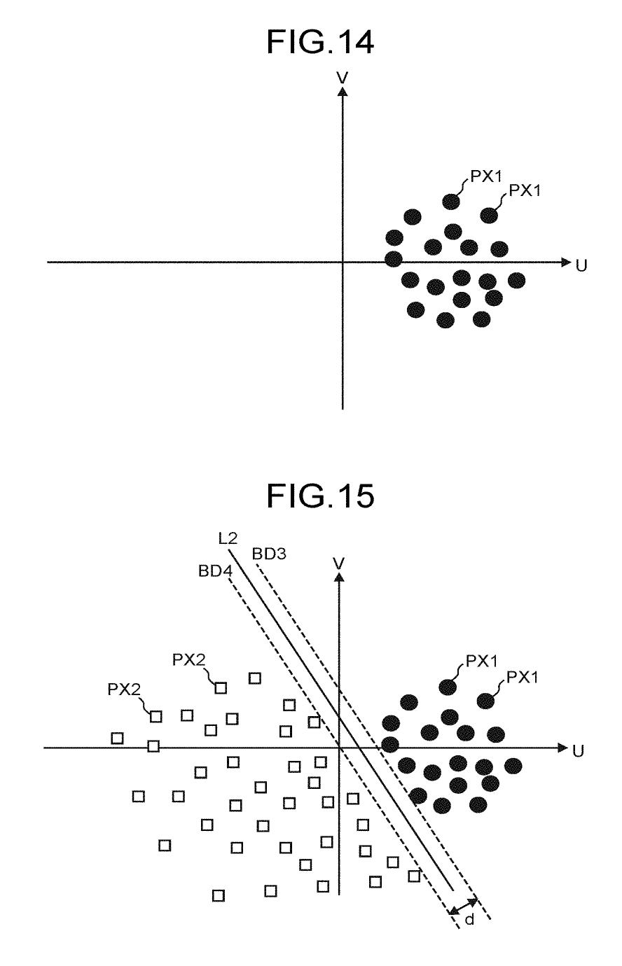

When generating the signal-color recognition dictionary DC2, the signal-candidate-region recognizer 30 cuts out the signal-recognition-processing target region 82 from the sample image data acquired by the in-vehicle camera 12 as the learning image data. FIG. 13 is a schematic diagram illustrating an example of an image including the traffic light 92 shot during the night. FIG. 14 is a diagram illustrating distribution of pixels PX1 and PX2 of the nighttime signal 93 in a (U, V) color space. FIG. 15 is an explanatory diagram of a method of identifying a region of the pixels PX1 of the nighttime signal 93 in the (U, V) color space and a region of the pixels PX2 other than the signal 93.

For example, the signal-candidate-region recognizer 30 collects pieces of image data of a region 85 being a region expanding outside the signal region 80 as illustrated in FIG. 10 and FIG. 13, in which a signal color of the blue signal 93B during the night is expanding. The signal-candidate-region recognizer 30 extracts the pixels PX1 in the region 85 in which the blue signal color is expanding, and obtains coordinates on the (U, V) color space of the pixels PX1 indicated by black circles in FIG. 14, to obtain a borderline BD3 of the region indicated by the coordinates illustrated in FIG. 15.

The signal-candidate-region recognizer 30 extracts the pixels PX2 in the region other than the region 85 in which the blue signal color is expanding, and obtains coordinates on the (U, V) color space of the pixels PX2 indicated by outlined squares in FIG. 15, to obtain a borderline BD4 of the region indicated by the coordinates.

The signal-candidate-region recognizer 30 performs learning by using the pieces of data of the pixels PX1 in the region 85 in which the blue signal color is expanding and the pixels PX2 in the region other than the region 85, to generate the signal-color recognition dictionary DC2 for recognizing the pixels PX1 of the night blue signal 93B.

For example, the signal-candidate-region recognizer 30 generates the signal-color recognition dictionary DC2 including coefficients a, b, and c of an evaluation function f(U, V) represented by the following equation (5) according to the SVM machine learning technique. The signal-candidate-region recognizer 30 calculates the coefficients a, b, and c of the evaluation function f(U, V) indicated by a solid line L2 illustrated in FIG. 15 so that the distance d between the borderlines BD3 and BD4 becomes maximum according to the SVM machine learning technique, to generate the signal-color recognition dictionary DC2 including the coefficients a, b, and c. Similarly, the signal-candidate-region recognizer 30 calculates the coefficients a, b, and c of the evaluation function f(U, V) also for the red signal 93R and the yellow signal 93Y, to generate the signal-color recognition dictionary DC2 for the nighttime.

f(U,V)=a×U+b×V+c (5)

If a value of the evaluation function f(U, V) in which a U value and a V value of the pixels of the image data to be identified are substituted is equal to or larger than a preset threshold Thre, the signal-candidate-region recognizer 30 recognizes that the pixels are those of the signal 93. On the other hand, if the value of the evaluation function f(U, V) in which the U value and the V value of the pixels of the image data to be identified are substituted is smaller than the preset threshold Thre, the signal-candidate-region recognizer 30 recognizes that the pixels are not those of the signal 93.

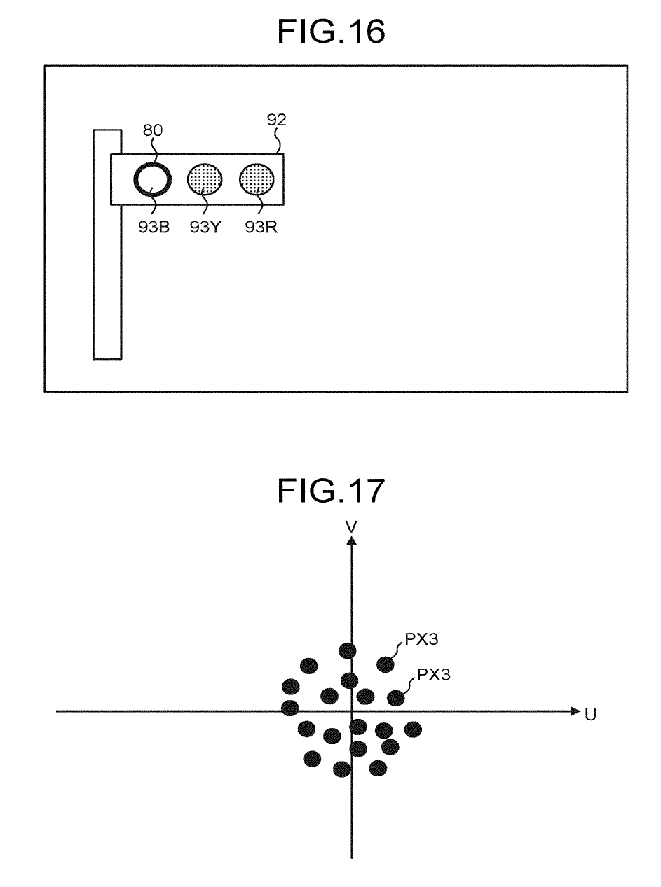

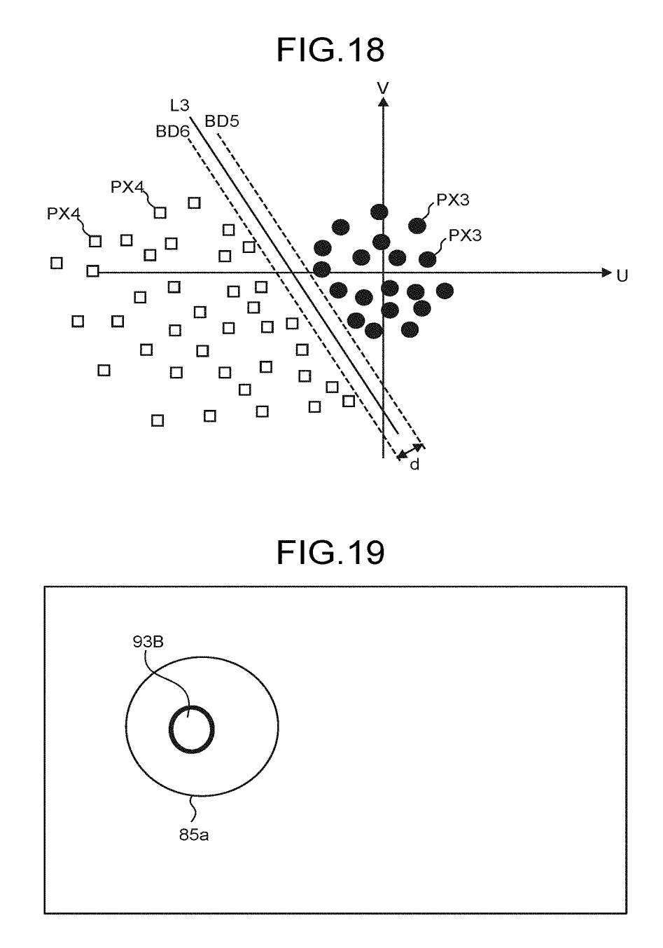

FIG. 16 is a schematic diagram illustrating an example of an image including the traffic light 92 and shot during the day. FIG. 17 is a diagram illustrating distribution of pixels PX3 in the daytime signal region 80 in the (U, V) color space. FIG. 18 is an explanatory diagram of a method of identifying a region of the pixels PX3 in the daytime signal region 80 in the (U, V) color space, and a region of pixels PX4 in a region other than the signal region 80.

The signal-candidate-region recognizer 30 collects pieces of data of the signal region 80 of the daytime blue signal 93B as illustrated in FIG. 9 and FIG. 16. The signal-candidate-region recognizer 30 extracts the pixels PX3 in the blue signal region 80 and obtains coordinates on the (U, V) color space of the pixels PX3 indicated by black circles in FIG. 17, to obtain a borderline BD5 of the region indicated by the coordinates.

The signal-candidate-region recognizer 30 extracts the pixels PX4 in a region other than the blue signal region 80, and obtains coordinates on the (U, V) color space of the pixels PX4 as illustrated by outlined squares in FIG. 18, to obtain a borderline BD6 of the region indicated by the coordinates.

The signal-candidate-region recognizer 30 performs learning by using the pieces of data of the pixels PX3 in the signal region 80 and the pixels PX4 in the region other than the signal region 80 to generate the signal-color recognition dictionary DC2 for recognizing the pixels PX3 of the daytime blue signal 93B. The signal-candidate-region recognizer 30 calculates the coefficients a, b, and c of the evaluation function f(U, V) for the daytime illustrated by a solid line L3 in FIG. 18 for each color, so that the distance d between the borderlines BD5 and BD6 becomes maximum, for example, according to the SVM machine learning technique described above, to generate the signal-color recognition dictionary DC2.

The signal-candidate-region recognizer 30 extracts the pixels of the signal 93 by identifying whether the pixels are those of the signal 93, depending on whether the evaluation function f(U, V) is equal to or larger than the threshold Thre described above based on the generated evaluation function f(U, V).

The signal-shape recognizer 32 performs expansion processing with respect to the target region of the pixels of the signal 93 extracted by the signal-candidate-region recognizer 30 (S216).

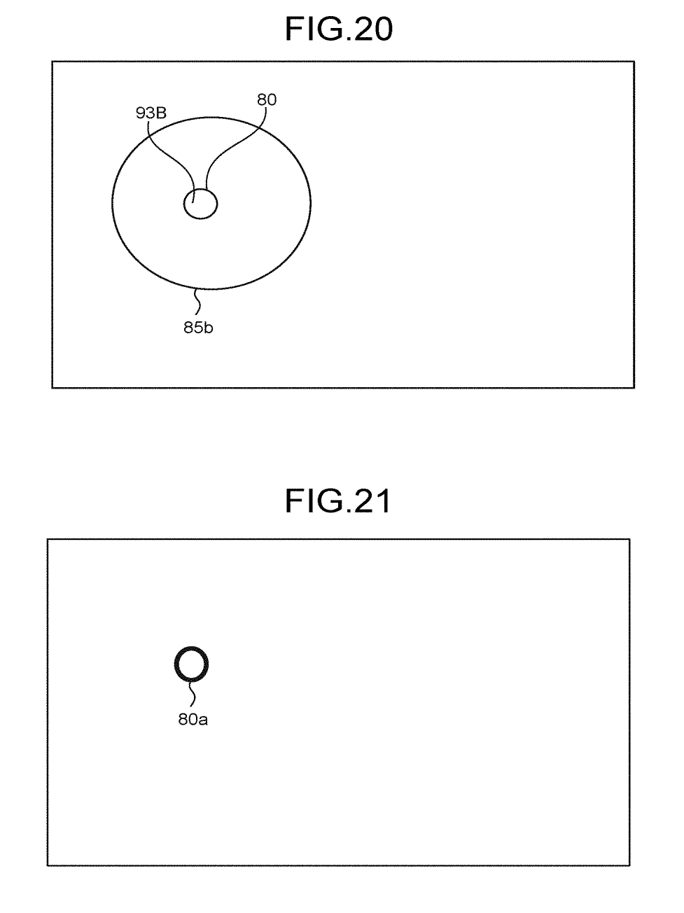

FIG. 19 is a diagram of a pixel region 85a obtained by extracting the pixels of the region 85 in which a signal color of the nighttime blue signal 93B expands before the expansion processing. FIG. 20 is a diagram of a pixel region 85b obtained by extracting the pixels of the region 85 in which the signal color of the nighttime blue signal 93B expands after the expansion processing.

In the case of the image data of the nighttime blue signal 93B as illustrated in FIG. 10 and FIG. 13, because saturated pixels and noise pixels are included in the region 85 in which the signal color of the blue signal 93B expands, the pixel region 85a obtained by extracting the region 85 in which the signal color expands in the (U, V) color space illustrated in FIG. 19 may not include all the pixels of the region 85 of the blue signal 93B. Therefore, the signal-shape recognizer 32 performs the expansion processing with respect to the extracted pixel region 85a to generate the expanded pixel region 85b illustrated in FIG. 20. Accordingly, the signal-shape recognizer 32 includes in the pixel region 85b the pixels missing from the pixel region 85a, among the pixels included in the region 85 in which the signal color of the blue signal 93B expands. Further, the signal-shape recognizer 32 generates the signal region 80 indicating the original region of the blue signal 93B in the pixel region 85b. For example, as the expansion processing, the signal-shape recognizer 32 adds N×N pixel blocks to the image before the expansion processing. For example, in the case of N=7, the signal-shape recognizer 32 adds 7×7 pixel blocks to the image before the expansion processing with respect to one pixel to be expanded.

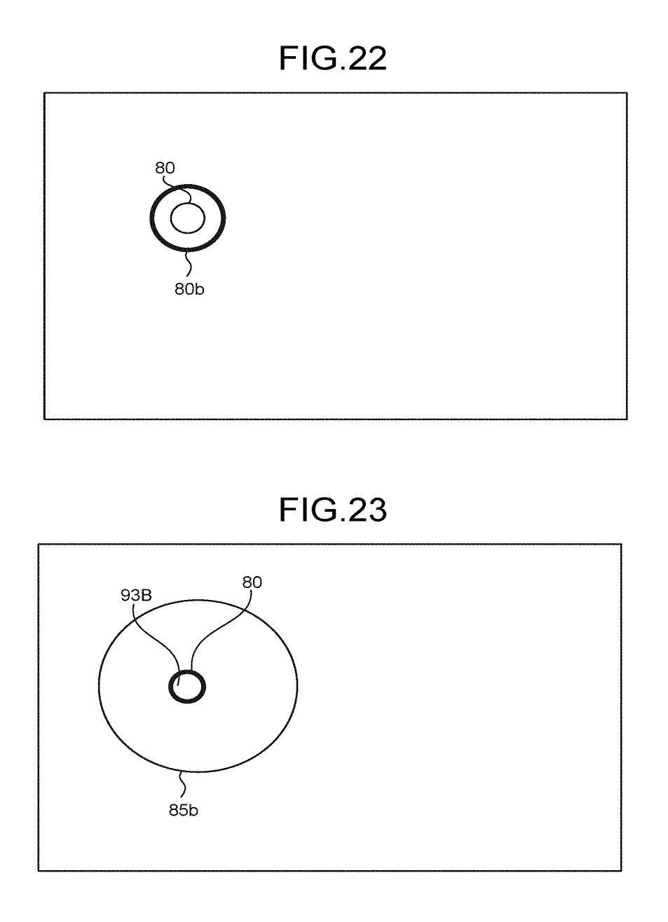

FIG. 21 is a diagram of a pixel region 80a obtained by extracting the pixels in the region of the daytime blue signal 93B before the expansion processing. FIG. 22 is a diagram of a pixel region 80b obtained by extracting the pixels in the region of the daytime blue signal 93B after the expansion processing.

In the case of the image data of the daytime blue signal 93B as illustrated in FIG. 9 and FIG. 16, because saturated pixels and noise pixels are included in the signal region 80 of the blue signal 93B, the pixel region 80a obtained by extracting the pixels of the blue signal 93B in the (U, V) color space illustrated in FIG. 21 may not include all the pixels in the region of the blue signal 93B. Therefore, the signal-shape recognizer 32 performs the expansion processing to the extracted pixel region 80a to generate the expanded pixel region 80b illustrated in FIG. 22. Accordingly, the signal-shape recognizer 32 includes in the pixel region 80b the pixels missing from the pixel region 80a, among the pixels included in the signal region 80 of the blue signal 93B. Further, the signal-shape recognizer 32 generates the signal region 80 indicating the original region of the blue signal 93B in the pixel region 85b. For example, as the expansion processing, the signal-shape recognizer 32 adds an N×N pixel block to the image before the expansion processing. For example, in the case of N=7, the signal-shape recognizer 32 adds a 7×7 pixel block to the image before the expansion processing with respect to one pixel to be expanded.

The signal-shape recognizer 32 extracts a circular shape from the pixel regions 85b and 80b of the expanded signal 93 and performs shape recognition processing for recognizing the shape of the signal 93 (S218).

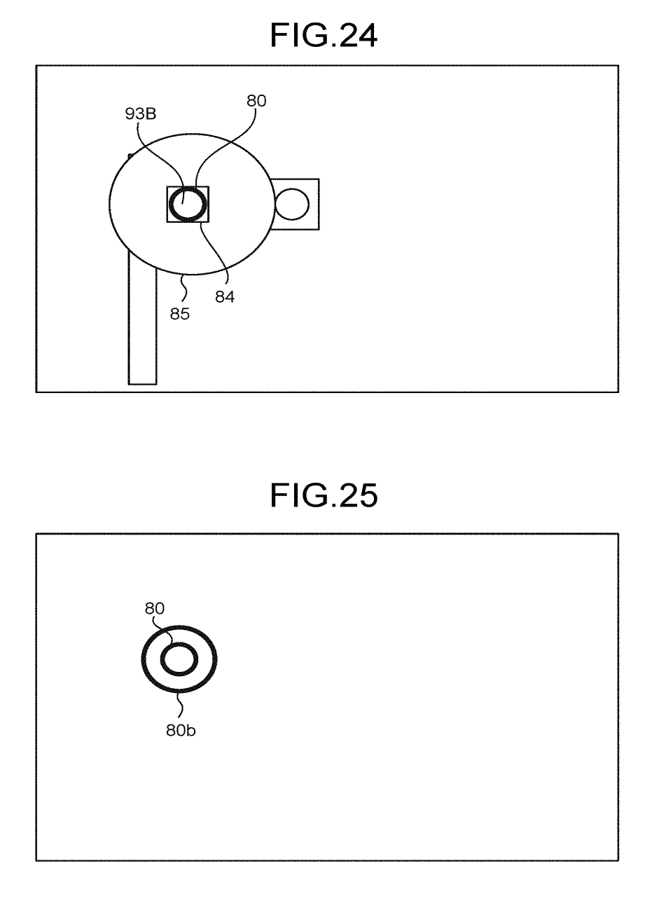

FIG. 23 is a diagram illustrating the circular signal region 80 indicating an image of the nighttime blue signal 93B, which is extracted by the signal-shape recognizer 32 according to the Hough transform. FIG. 24 is a diagram illustrating the rectangular recognition region 84 circumscribed to the circular signal region 80 in which the signal-shape recognizer 32 indicates the image of the nighttime blue signal 93B.

When recognizing that the signal region 80 of the blue signal 93B as a circular shape, the signal-shape recognizer 32 determines that the blue signal 93B is present. Specifically, the signal-shape recognizer 32 extracts a circular shape illustrated in FIG. 23 in the signal region 80 the blue signal 93B is present according to the Hough transform. As illustrated in FIG. 24, the signal-shape recognizer 32 obtains the recognition region 84, which is a rectangular shape circumscribed to the extracted circular signal region 80. The signal-shape recognizer 32 sets the region of the recognition region 84 as a result region obtained by detecting the blue signal 93B.

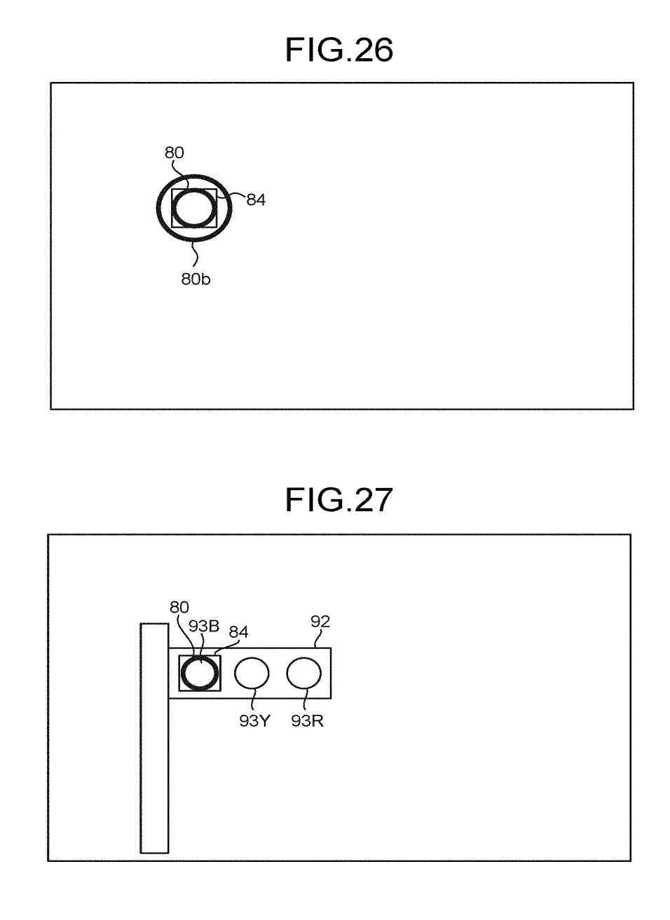

FIG. 25 is a diagram illustrating the circular signal region 80 indicating an image of the daytime blue signal 93B, which is extracted by the signal-shape recognizer 32 according to the Hough transform. FIG. 26 is a diagram illustrating the recognition region 84 of the circular signal region 80 in which the signal-shape recognizer 32 indicates the image of the daytime blue signal 93B. FIG. 27 is another diagram illustrating the recognition region 84 of the circular signal region 80 in which the signal-shape recognizer 32 indicates the image of the daytime blue signal 93B.

When recognizing the signal region 80 of the blue signal 93B as the circular shape, the signal-shape recognizer 32 determines that the blue signal 93B is present. Specifically, the signal-shape recognizer 32 extracts the circular shape illustrated in FIG. 25, in the signal region 80 where the blue signal 93B is present according to the Hough transform. As illustrated in FIG. 26 and FIG. 27, the signal-shape recognizer 32 obtains the recognition region 84, which is a rectangle shape circumscribed to the extracted circular signal region 80. The signal-shape recognizer 32 sets the region of the recognition region 84 as the result region obtained by detecting the blue signal 93B.

The signal-shape recognizer 32 similarly performs the shape recognition processing with respect to the yellow signal 93Y and the red signal 93R, to generate the result region obtained by detecting the yellow signal 93Y and the red signal 93R.

The signal-shape recognizer 32 outputs the information related to the region of the recognition region 84 to the signal-detection-result output unit 34, as a detection result of detecting the traffic light 92. The signal-detection-result output unit 34 outputs the acquired detection result to a display device or the like (S220).

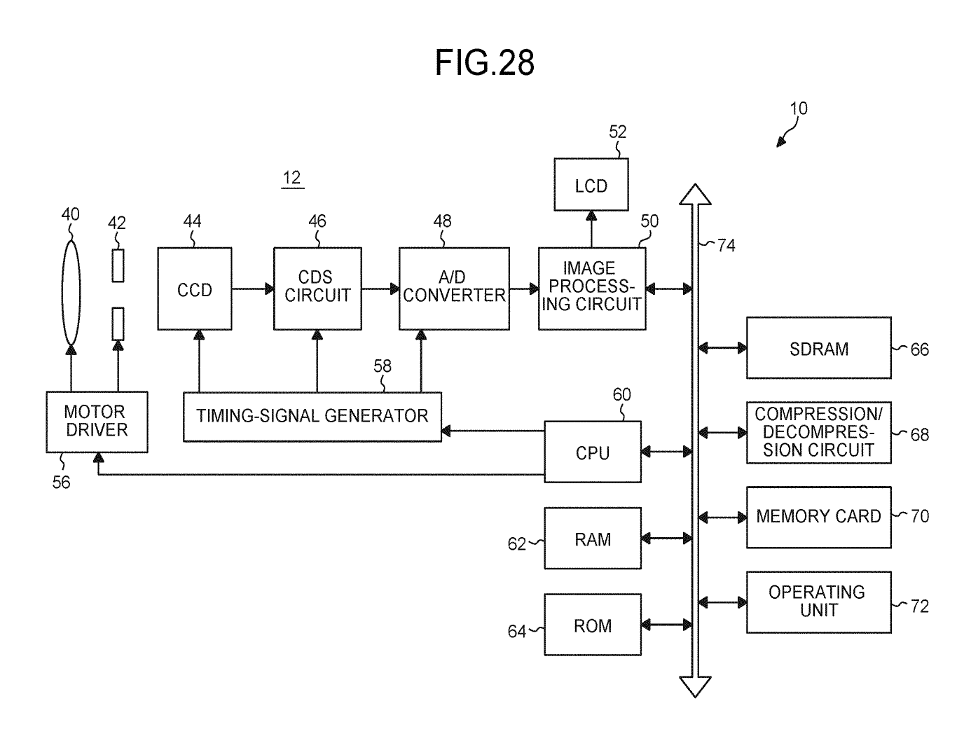

FIG. 28 is a block diagram illustrating a hardware configuration of the recognition device 10 including the in-vehicle camera 12. As illustrated in FIG. 28, the recognition device 10 including the in-vehicle camera 12 includes an imaging optical system 40 including a lens, a mechanical shutter 42, a CCD (Charge Coupled Device) 44, a CDS (Correlated Double Sampling) circuit 46, an A/D converter 48, an image processing circuit 50, a liquid-crystal display (hereinafter, “LCD 52”), a motor driver 56, a timing-signal generator 58, a CPU (Central Processing Unit) 60, a RAM (Random Access Memory) 62, a ROM (Read Only Memory) 64, an SDRAM (Synchronous Dynamic RAM) 66, a compression/decompression circuit 68, a memory card 70, and an operating unit 72.

In the camera 12, the CCD 44 receives light of an object through the imaging optical system 44. The shutter 42 is arranged between the imaging optical system 40 and the CCD 44, and incident light to the CCD 44 can be blocked by the shutter 42. The imaging optical system 40 and the shutter 42 are driven by the motor driver 56.

The CCD 44 outputs analog image data obtained by converting an optical image imaged on an imaging area into an electric signal to the CDS circuit 46. The CDS circuit 46 removes noise components from the image data and outputs the image data to the A/D converter 48. The A/D converter 48 converts the analog image data to a digital value, and outputs the digital value to the image processing circuit 50.

The image processing circuit 50 uses the SDRAM 66 that temporarily stores therein image data to perform various types of image processing such as YCrCb conversion processing, white balance control processing, contrast correction processing, edge enhancement processing, and color conversion processing. The white balance processing is image processing for adjusting the concentration of colors of the image information. The contrast correction processing is image processing for adjusting the contrast of the image information. The edge enhancement processing is image processing for adjusting sharpness of the image information. The color conversion processing is image processing for adjusting the hue of the image information. The image processing circuit 50 outputs the image data having been subjected to the signal processing and the image processing to the LCD 52 so that the image is displayed on the LCD 52.

The image processing circuit 50 records the image data having been subjected to the signal processing and the image processing in the memory card 70 via the compression/decompression circuit 68. The compression/decompression circuit 68 compresses the image data output from the image processing circuit 50 and stores the image data in the memory card 70 in response to an instruction acquired from the operating unit 72. The compression/decompression circuit 68 expands the image data read out from the memory card 70 and outputs the expanded image data to the signal processor 20.

The timing of the CCD 44, the CDS circuit 46, and the A/D converter 48 is controlled by the CPU 60 connected thereto via the timing signal generator 58 that generates a timing signal. The image processing circuit 50, the compression/decompression circuit 68, and the memory card 70 are controlled by the CPU 60.

The CPU 60 performs various types of arithmetic processing according to a program. The CPU 60 is interconnected with the ROM 64 that is a read only memory storing therein a program and the like, the RAM 62 that is a readable and writable memory having a work area to be used in various processes and various data storage areas, the SDRAM 66, the compression/decompression circuit 68, the memory card 70, and the operating unit 72 by a bus line 74.

The image data output by the in-vehicle camera 12 described above is input to a board functioning as the signal processor 20 or the recognition processor 18 of the recognition device 10 illustrated in FIG. 2 and FIG. 3.

Programs for the dictionary generation processing, the time period identifying processing, and the signal recognition processing performed by the recognition device 10 according to the present embodiment can be recorded on a computer-readable recording medium such as a CD-ROM, a flexible disk (FD), a CD-R, or a DVD (Digital Versatile Disk) in an installable format or an executable format and provided.

Furthermore, the programs for the dictionary generation processing, the time period identifying processing, and the signal recognition processing performed by the recognition device 10 according to the present embodiment can be configured to be stored in a computer connected to a network such as the Internet and provided by downloading the programs via the network. Further, the programs for the dictionary generation processing, the time period identifying processing, and the signal recognition processing performed by the recognition device 10 according to the present embodiment can be configured to be provided or distributed via the network such as the Internet.

Further, the programs for the dictionary generation processing, the time period identifying processing, and the signal recognition processing performed by the recognition device 10 according to of the present embodiment can be configured to be incorporated beforehand in the ROM 64 or the like and provided.

The programs for the dictionary generation processing, the time period identifying processing, and the signal recognition processing performed by the recognition device 10 according to the present embodiment have a module configuration including respective units of the signal processor 20 or the recognition processor 18 illustrated in FIG. 2 and FIG. 3 (the image acquirer 22, the time period identifier 24, the signal-recognition-dictionary input unit 26, the position-information input unit 27, the signal-recognition-processing target-region input unit 28, the signal-candidate-region recognizer 30, the signal-shape recognition unit 32, and the signal-detection-result output unit 34). As the actual hardware, the CPU (processor) reads out the programs for the dictionary generation processing, the time period identifying processing, and the signal recognition processing from the above-described recording medium and executes the programs, thereby loading the respective units described above onto a main storage device. Accordingly, the image acquirer 22, the time period identifier 24, the signal-recognition-dictionary input unit 26, the position-information input unit 27, the signal-recognition-processing target-region input unit 28, the signal-candidate-region recognizer 30, the signal-shape recognition unit 32, and the signal-detection-result output unit 34 are generated on the main storage device.

As described above, the recognition device 10 sets the signal-recognition-processing target region 82, being the search range of the signal, so as to include a plurality of signal shapes recognized based on a plurality of images. Therefore, it can be suppressed that the detection accuracy of the traffic light 92 decreases due to external factors or the like.

The recognition device 10 sets the signal-recognition-processing target region 82 associated with the time period, for example, day and night, thereby enabling to respond to the expansion of the signal 93 different depending on the time period, and the traffic light 92 can be detected accurately.

The recognition device 10 can respond to the position of the signal 93 in the image different depending on an area by setting the signal-recognition-processing target region 82 associated with the area corresponding to the position, and the traffic light 92 can be detected accurately. Further, when there is no signal-recognition-processing target region 82 associated with the current area, the recognition device 10 can quickly respond to the position of the signal 93 in a new area by newly setting a signal-recognition-processing target region 82 in that area, and the traffic light 92 can be detected accurately. By setting the signal-recognition-processing target region 82 associated with the area and the time period, the recognition device 10 can respond to the position of the signal 93 in the image, which is different depending on the area and the time period, and the traffic light 92 can be detected accurately.

By setting the signal-recognition-processing target region 82 for each state, the recognition device 10 can respond to the position of the signal 93 in the image even in different states, thereby enabling to detect the traffic light 92 accurately.

When the surrounding state changes, the recognition device 10 updates the signal-recognition-processing target-region dictionary DC3 based on the new signal-recognition-processing target region 82, thereby enabling to respond to the position of the signal 93 in the image and detect the traffic light 92 accurately, even if the state changes.

By updating the signal-recognition-processing target-region dictionary DC3 based on the signal-recognition-processing target region 82 newly generated based on new image data, the recognition device 10 can respond to a change of the position of the signal 93 quickly, and the traffic light 92 can be detected accurately.

By setting an apex of a rectangular region including the shapes of a plurality of signals 93 as coordinate data of the signal-recognition-processing target region 82, the recognition device 10 can detect the traffic light 92 accurately, while suppressing detection omission of the signal 93.

### Second Embodiment

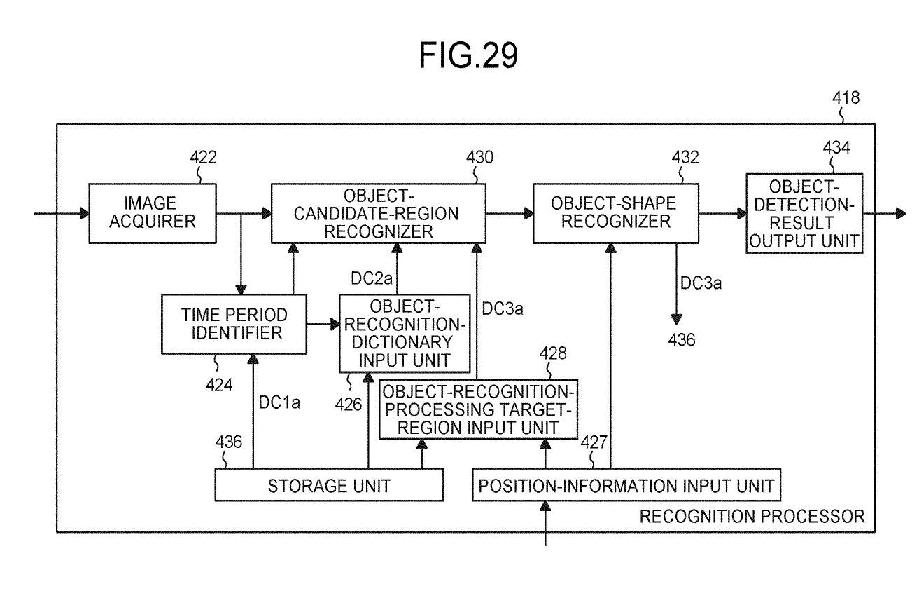

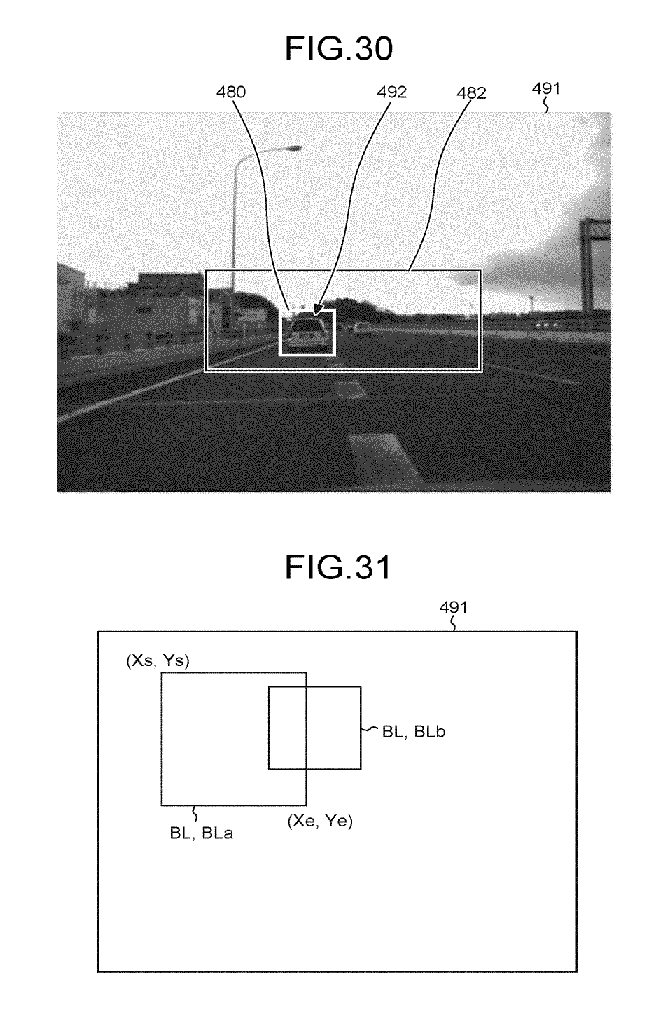

A second embodiment in which a vehicle is an object to be recognized is described next. The second embodiment has configurations substantially identical to those of the first embodiment except that the configuration of a recognition processor 418 is different from the recognition processor according to the first embodiment. Therefore, in the second embodiment, the recognition processor 418 is described. FIG. 29 is a functional block diagram of the recognition processor 418 according to the second embodiment. FIG. 30 is an example of an image 491 acquired by an image acquirer 422.

As illustrated in FIG. 29, the recognition processor 418 includes the image acquirer 422, a time period identifier 424, an object-recognition-dictionary input unit 426, a position-information input unit 427, an object-recognition-processing target-region input unit 428, an object-candidate-region recognizer 430, an object-shape recognizer 432, an object-detection-result output unit 434, and a storage unit 436.

The image acquirer 422 acquires image data of an image including another vehicle 492 as illustrated in FIG. 30 shot by the camera 12 from the interface unit 16, in object detection (for example, vehicle detection).

The time period identifier 424 identifies a time period of the image acquired from the image acquirer 422, based on a time period identifying dictionary DCla stored in the storage unit 436.

In the object detection, the object-recognition-dictionary input unit 426 acquires an object recognition dictionary DC2a including pixel information and the like such as color of a vehicle corresponding to the time period output by the time period identifier 424 from the storage unit 436 and outputs the object recognition dictionary DC2a to the object-candidate-region recognizer 430.

In the object detection, the position-information input unit 427 acquires position information detected by the position detector 14. The position-information input unit 427 outputs the acquired position information to the object-recognition-processing target-region input unit 428 and the object-shape recognizer 432.

In the object detection, the object-recognition-processing target-region input unit 428 acquires the object-recognition-processing target-region dictionary DC3a including information related to an object-recognition-processing target region 482 (for example, coordinate data), being a search range of the vehicle 492 in the image from the storage unit 436 and outputs the object-recognition-processing target-region dictionary DC3a to the object-candidate-region recognizer 430.

In the object detection, the object-candidate-region recognizer 430 sets the object-recognition-processing target region 482 in the image in the detection of the vehicle 492, based on the object-recognition-processing target-region dictionary DC3a. The object-candidate-region recognizer 430 extracts pixel data of the vehicle 492 in the object-recognition-processing target region 482 based on the object recognition dictionary DC2a, and outputs the pixel data to the object-shape recognizer 432.

In the object detection, the object-shape recognizer 432 recognizes the shape of a rectangular object region 480 in which, for example, the vehicle 492 is present, based on the pixel data of the vehicle 492 acquired from the object-candidate-region recognizer 430, and outputs the shape of the object region 480 to the object-detection-result output unit 434 as the shape of the vehicle 492. The object-shape recognizer 432 generates or updates the object-recognition-processing target-region dictionary DC3a according to the learning method and stores the object-recognition-processing target-region dictionary DC3a in the storage unit 436.

In the object detection, the object-detection-result output unit 434 outputs a detection result of the vehicle 492 to a voice output device, a display device or the like.

The storage unit 436 is a storage device that store a program for detecting the vehicle 492 and the dictionaries DC1a, DC2a, and DC3a required for the execution of the program.

Generation and update of the object-recognition-processing target-region dictionary DC3a to be used for detection of the vehicle 492 by the object-candidate-region recognizer 430 and the object-shape recognizer 432 are described next.

FIG. 31 is a diagram in which a block BL is set in the image 491. As illustrated in FIG. 31, the object-candidate-region recognizer 430 sets a block BL, whose size and position are decided by a coordinate (Xs, Ys) and a coordinate (Xe, Ye) of two apexes (for example, an upper left apex and a lower right apex) on a diagonal line, in the image 491 in generation or update of the object-recognition-processing target-region dictionary DC3a by learning. The object-candidate-region recognizer 430 can set the block BL based on information of the object-recognition-processing target region 482 included in the object-recognition-processing target-region dictionary DC3a. The object-candidate-region recognizer 430 scans the set block BL in the image, to detect a block BL whose size substantially matches with the image of the vehicle 492, being an object to be recognized. It is desired here that the object-candidate-region recognizer 430 sequentially selects and scans the image from a block BLa having a large size to a block BLb having a small size illustrated in FIG. 31. In the second embodiment, the object-candidate-region recognizer 430 normalizes the block BL. Therefore, the processing time is the same regardless of the size of the block BL. The number of blocks BLa having a large size in the image is less than the number of blocks BLb having a small size in the image. Therefore, the object-candidate-region recognizer 430 selects and scans the image from the blocks BLa having a large size, and thus the vehicle 492 in the image 491 can be detected quickly. Accordingly, when the object-candidate-region recognizer 430 selects the block BL having a large size and detects a large image of the vehicle 492, the user feels a sense of faster driving. The object-candidate-region recognizer 430 outputs data of the block BL and the pixel value in the block BL to the object-shape recognizer 432.

The object-shape recognizer 432 calculates a feature hₜ(x) of the block BL based on the data of the block BL and the pixel value in the block BL.

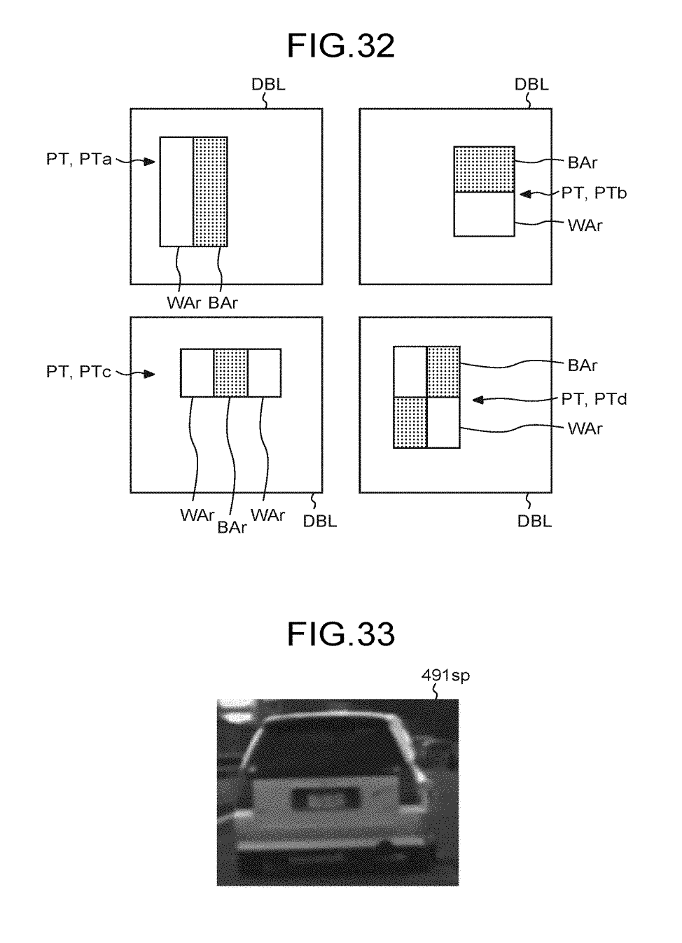

FIG. 32 is a diagram illustrating an example of a feature pattern in a dictionary block DBL registered in a recognition dictionary for calculating the feature. The recognition dictionary preset and stored in the storage unit 436 includes information of pixel values of respective feature patterns PTa, PTb, PTc, and PTd set in the dictionary block DBL illustrated in FIG. 32. The four feature patterns PTa, PTb, PTc, and PTd substantially correspond to features of almost any object. The feature pattern PT includes a rectangular white region WAr constituted by only white pixels in the dictionary block DBL, and a rectangular black region BAr constituted by only black pixels in the dictionary block DBL. The feature pattern PTa includes the white region WAr and the black region BAr located right and left adjacent to each other, and is located upper left as viewed from the center of the dictionary block DBL. The feature pattern PTb includes the white region WAr and the black region BAr located up and down adjacent to each other, and is located upper right as viewed from the center of the dictionary block DBL. The feature pattern PTc, in which the black region BAr is sandwiched between two white regions WAr adjacent to each other, is located on an upper side as viewed from the center of the dictionary block DBL. The feature pattern PTd, in which the two white regions WAr and the two black regions BAr are located respectively diagonally, is located on the left side as viewed from the center of the dictionary block DBL.

The object-shape recognizer 432 calculates the feature hₜ(x) of the block BL of the acquired image based on the pixel value of the feature pattern PT in the dictionary block DBL. The object-shape recognizer 432 calculates a difference between the pixel value of the white region WAr and the pixel value of the black region BAr in the dictionary block DBL and the pixel value in the block BL of the acquired image. The object-candidate-region recognizer 430 calculates a total value of an absolute value of the difference as the feature hₜ(x) in the block BL of the acquired image. The object-shape recognizer 432 calculates a set of the T features hₜ(x) in the block BL of the acquired image. T is the number of the feature patterns PT. The object-shape recognizer 432 calculates an evaluation value f(x) based on the set of the features hₜ(x) and the following equation (6).

$$f ( x ) = {\sum }_{t = 1}^{T} {α}_{t} {h}_{t} ( x ) \qquad ( 6 )$$

Here, αₜ is a weight coefficient associated with the respective feature patterns PT, and is stored in the recognition dictionary in the storage unit 436. The object-shape recognizer 432 calculates the features hₜ(x) and the weight coefficient αₜ beforehand by learning. FIG. 33 is a diagram illustrating an example of a learning image sample 491sp. For example, the object-shape recognizer 432 can collect a plurality of learning image samples 491sp of the vehicle 492 extracted beforehand as illustrated in FIG. 33, and set the features h_{L}(x) and the weight coefficient αₜ beforehand by learning based on the learning image samples 491sp.

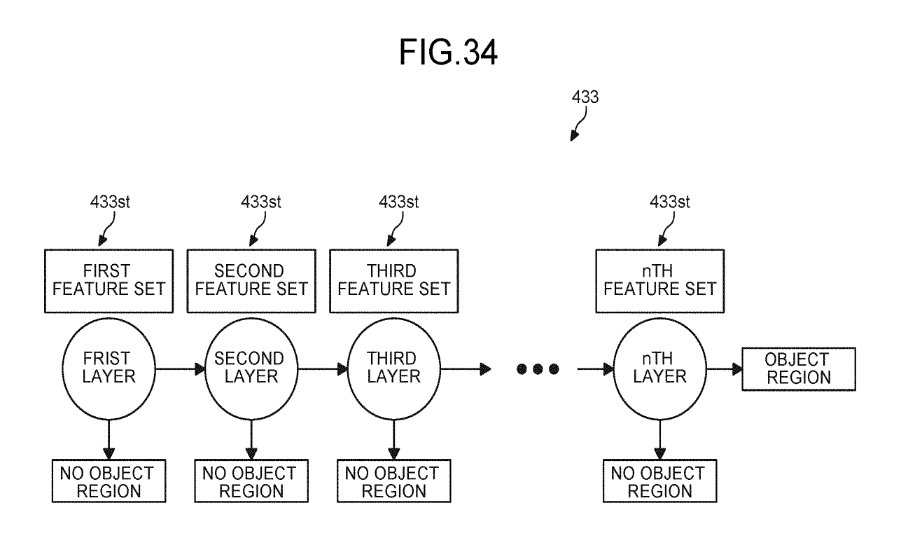

FIG. 34 is a diagram of an object identifier 433 provided in the object-shape recognizer 432. The object-shape recognizer 432 includes the object identifier 433 illustrated in FIG. 34. The object-shape recognizer 432 determines whether the block BL is the object region 480 by using the object identifier 433. In the second embodiment, the object region 480 is a vehicle region including the vehicle 492.

The object-shape recognizer 432 calculates the evaluation value f(x) based on the equation (6) in each layer 433st. Specifically, the object-shape recognizer 432 calculates the evaluation value f(x) based on the equation (6) using one or a plurality of feature patterns PT unique to each object to be detected (that is, each vehicle 492) and the weight coefficient αₜ in each layer 433st. The object-shape recognizer 432 compares the evaluation value f(x) with a preset evaluation threshold in each layer 433st to evaluate the evaluation value f(x). It is desired that the feature hₜ(x), the weight coefficient αₜ, and the evaluation threshold in each layer 433st are preset by performing learning using a learning image of an object to be detected, and a learning image of an object that is not a detection target.

If the evaluation value f(x) is smaller than the evaluation threshold of the preset layer 433st in each layer 433st, the object-shape recognizer 432 determines that the block BL in which the evaluation value f(x) has been calculated is not the object region 480, that is, the block BL is not a region including the vehicle 492 (that is, determines that the block BL is a no object region that does not include an object), to finish evaluation regarding the block BL.

On the other hand, if the evaluation value f(x) is larger than the preset evaluation threshold, the object-shape recognizer 432 calculates the evaluation value f(x) in the next layer 433st, and evaluates the evaluation value f(x) again, based on the evaluation threshold of the layer 433st. Thereafter, when having determined that the evaluation value f(x) is larger than the preset evaluation threshold of the layer 433st in the last nth layer 433st, the object-shape recognizer 432 determines that the block BL is the object region 480.

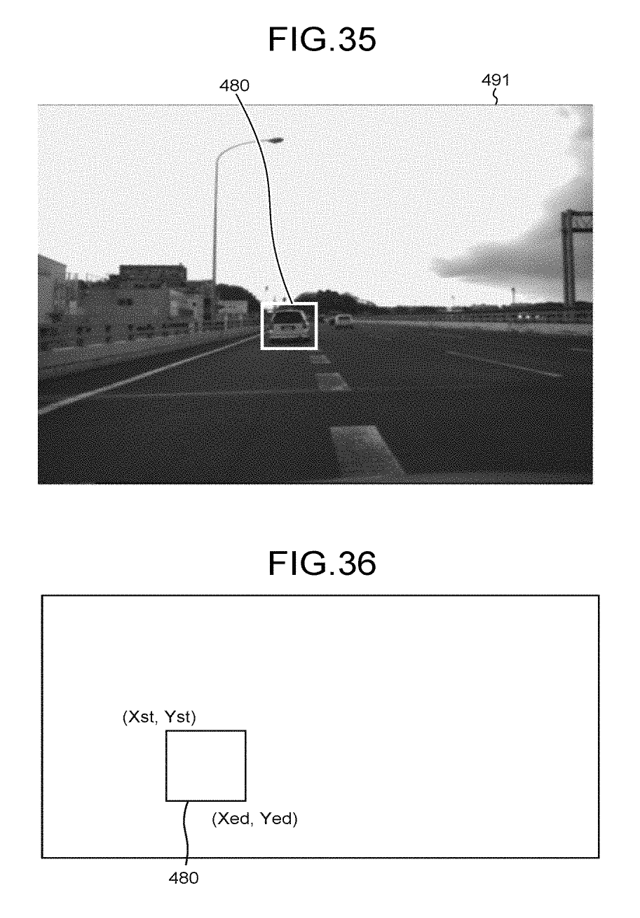

FIG. 35 is an explanatory diagram of the object region 480 in the image 491. For example, the object-shape recognizer 432 recognizes a rectangular block BL indicated by a white frame in the image 491 in FIG. 35 as the object region 480.

FIG. 36 is an explanatory diagram of a recognition result of the object region 480. As illustrated in FIG. 36, the object-shape recognizer 432 extracts the coordinate (Xst, Yst) and the coordinate (Xed, Yed) of two apexes on a diagonal line (for example, an upper left apex and a lower right apex) of the recognized rectangular object region 480.

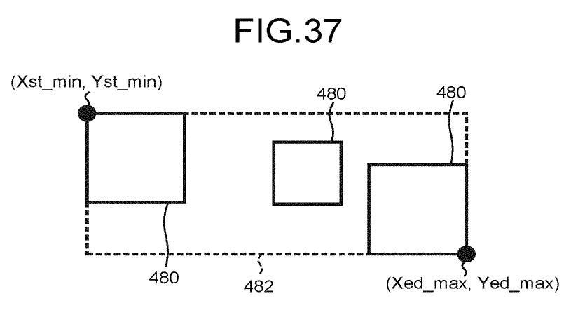

FIG. 37 is an explanatory diagram of setting of the object-recognition-processing target region 482 based on a plurality of object regions 480. When having detected the plurality of object regions 480 from the object-recognition-processing target region 482, the object-shape recognizer 432 obtains the coordinate (Xst[i], Yst[i]) and the coordinate (Xed[i], Yed[i]) of the two apexes of the respective object regions 480. In this case, the object-shape recognizer 432 obtains the minimum coordinate (Xst_min, Yst_min) and the maximum coordinate (Xed_max, Yed_max), among the coordinates of the plurality of object regions 480, as illustrated in FIG. 37. The object-shape recognizer 432 sets a rectangular region decided by the obtained coordinate (Xst_min, Yst_min) and the obtained coordinate (Xed_max, Yed_max) as the object-recognition-processing target region 482, to update the object-recognition-processing target-region dictionary DC3a.

The object-shape recognizer 432 can acquire the position information detected by the GPS or the like from the position-information input unit 427, and generate the object-recognition-processing target-region dictionary DC3a for each area. Accordingly, the object-shape recognizer 432 can generate the object-recognition-processing target-region dictionary DC3a that can respond to a difference of a landform of different areas. In this case, the object-candidate-region recognizer 430 acquires the corresponding object-recognition-processing target-region dictionary DC3a from the storage unit 436, based on the position information acquired from the position-information input unit 427.

As described above, the recognition processor 418 according to the second embodiment detects the vehicle 492 in one or a plurality of images newly acquired to recognize the new object region 480 and perform learning, thereby generating and updating the object-recognition-processing target-region dictionary DC3a. Accordingly, the recognition processor 418 can generate the object-recognition-processing target-region dictionary DC3a that can respond to different vehicles 492 and different installation states of the camera 12.

The recognition processor 418 can generate a new object-recognition-processing target-region dictionary DC3a even if the installation state of the camera 12 changes, by detecting a plurality of vehicles 492 in an image and recognizing a new object region 480 to set the object-recognition-processing target region 482.

Even if the camera 12 is moved to a new area, the recognition processor 418 can generate a new object-recognition-processing target-region dictionary DC3a corresponding to the new area, by detecting a plurality of vehicles 492 in an image and recognizing a new object region 480 to set the object-recognition-processing target region 482.

When a certain period of time has passed, the installation state of the camera 12 frequently changes. Therefore, the recognition processor 418 can generate a new object-recognition-processing target-region dictionary DC3a by detecting a plurality of vehicles 492 in an image and recognizing a new object region 480 to set the object-recognition-processing target region 482.

Functions, arrangement, connecting relations, and the number of the constituent elements in configurations of the respective embodiments described above can be modified as appropriate. Further, the respective embodiments described above can be combined.

For example, in the second embodiment described above, the vehicle 492 has been described as an example of an object to be recognized. However, the present invention is not limited thereto. For example, the object to be recognized can be a sign such as a road sign. In this case, the recognition processor 418 detects a sign as an object, and recognizes a region including the sign as the object region 480. The recognition processor 418 generates and updates the object-recognition-processing target-region dictionary DC3a by setting the object-recognition-processing target region 482 based on a plurality of recognized object regions 480.

According to an embodiment, it is possible to shorten the time required for processing for recognizing a traffic light.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A recognition device comprising:
an image acquirer configured to acquire image data;
an object-candidate-region recognizer configured to set an object-recognition-processing target region in an image of the image data based on an object-recognition-processing target-region dictionary including information of the object-recognition-processing target region, the object-recognition-processing target region being a search range of an object to be recognized in the image of the image data; and
an object-shape recognizer configured to recognize a shape of the object in the object-recognition-processing target region, wherein
the object-shape recognizer generates the object-recognition-processing target-region dictionary including information of the object-recognition-processing target region that is set to include shapes of a plurality of objects recognized based on a plurality of pieces of the image data shot beforehand.

2. The recognition device according to claim 1, wherein
the image acquirer acquires a plurality of pieces of first image data in a first time period and a plurality of pieces of second image data in a second time period different from the first time period, and
the object-shape recognizer generates the object-recognition-processing target-region dictionary including information of a first object-recognition-processing target region set based on the pieces of first image data and information of a second object-recognition-processing target region set based on the pieces of second image data.

3. The recognition device according to claim 1, further comprising a position-information input unit configured to acquire position information that is information related to a position of the recognition device, wherein
the object-shape recognizer generates the object-recognition-processing target-region dictionary including information of a third object-recognition-processing target region set in a first area set in accordance with the position information and information of a fourth object-recognition-processing target region set in a second area set in accordance with the position information, the second area being different from the first area.

4. The recognition device according to claim 1, wherein
the image acquirer acquires the pieces of image data in different states, and
the object-shape recognizer generates the object-recognition-processing target-region dictionary including pieces of information of the plurality of object-recognition-processing target regions set for each of the states based on the pieces of image data.

5. The recognition device according to claim 1, wherein when surrounding states change, the object-shape recognizer updates the object-recognition-processing target-region dictionary based on information of an object-recognition-processing target region newly set based on new image data.

6. The recognition device according to claim 3, wherein when information of the object-recognition-processing target region corresponding to a current position has not been registered in the object-recognition-processing target-region dictionary, the object-shape recognizer adds information of a new object-recognition-processing target region set with respect to an area including the current position in the object-recognition-processing target-region dictionary, based on the position information.

7. The recognition device according to claim 1, further comprising a position-information input unit configured to acquire position information that is information related to a position of the recognition device, wherein
the object-shape recognizer generates the object-recognition-processing target-region dictionary including information of a plurality of object-recognition-processing target regions set based on the pieces of image data in a preset area and in a preset time period.

8. The recognition device according to claim 1, wherein the object-shape recognizer updates the object-recognition-processing target-region dictionary based on information of an object-recognition-processing target region newly set based on new image data.

9. The recognition device according to claim 1, wherein the object-shape recognizer generates the object-recognition-processing target-region dictionary by using coordinates of two apexes opposite to each other of a rectangle including shapes of a plurality of objects recognized based on the pieces of image data as the information of the object-recognition-processing target region.

10. A recognition method of an object comprising:
acquiring image data;
setting an object-recognition-processing target region in an image of the image data, based on an object-recognition-processing target-region dictionary including information of the object-recognition-processing target region, the object-recognition-processing target region being a search range of an object to be recognized in the image of the image data; and
recognizing a shape of the object in the object-recognition-processing target region, and
generating the object-recognition-processing target-region dictionary including information of the object-recognition-processing target region that is set to include shapes of a plurality of objects recognized based on a plurality of pieces of the image data shot beforehand.

11. A non-transitory computer-readable recording medium with an executable program stored thereon, wherein the program instructs a computer to perform:
acquiring image data;
setting an object-recognition-processing target region in an image of the image data, based on an object-recognition-processing target-region dictionary including information of the object-recognition-processing target region, the object-recognition-processing target region being a search range of an object to be recognized in the image of the image data; and
recognizing a shape of the object in the object-recognition-processing target region, and
generating the object-recognition-processing target-region dictionary including information of the object-recognition-processing target region that is set to include shapes of a plurality of objects recognized based on a plurality of pieces of the image data shot beforehand.
